(19) United States
(12) Patent Application Publication
(10) Pub. No.: US 2017/0011031 A1
(43) Pub. Date: Jan. 12, 2017

(54) SEARCH DEVICE, SEARCH METHOD, AND PROGRAM

(71) Applicant: T-TERMINOLOGY, LTD., Hasuda-shi (JP)

(72) Inventor: Tomoko TASHIRO, Saitama (JP)

(21) Appl. No.: 15/116,390

(22) PCT Filed: Feb. 4, 2015
(86) PCT No.: PCT/JP2015/053147

§ 371 Date: Aug. 3, 2016

(30) Foreign Application Priority Data
Feb. 4, 2014 (JP) 2014-019596

(51) Int. Cl. G06F 17/30; G06F 17/27; G06F 17/22

(52) U.S. Cl. CPC G06F 17/3028; G06F 17/30401; G06F 17/30654; G06F 17/2223; G06F 17/2735

(57) ABSTRACT

The present invention can accomplish effective and accurate searching even for long, multilingual search word input. On the basis of a search request that is denoted in a first system of symbols, a server outputs search results that are denoted in a second system of symbols. Specifically, a search request character string input unit inputs a user-generated search request that is denoted in the first system of symbols. A signifying language translation unit converts the input search request that is denoted in the first system of symbols into a signifying language that is different from the first system of symbols. A search unit performs a search that uses the search request in the signifying language and outputs search results that are denoted in the second system of symbols. A presentation control unit controls the presentation of the search results.

### TECHNICAL FIELD

The present invention relates to a search device, a search method and a program.

### BACKGROUND ART

Conventionally, on a document database, etc. (including so-called Websites on the Internet) realized by a system, various search devices for efficiently obtaining document data including the information targeted by a user have been proposed.

For example, Patent Document 1 discloses the following such search device. The search device extracts a single word serving as a keyword from a registered target document, references a plurality of word-group data having a specific meaning relative to this single word such as a different notation, variant character, equivalent term and synonym, and acquires a standard notation. Then, the search device creates search data associating the single word serving as the keyword, the word-group data including the standard notation, and the registered target document. Subsequently, while searching, the search device extracts the single word serving as the keyword from search conditions of the user, references a plurality of word-group data having a specific meaning relative to this single word such as a different notation, variant character, equivalent term and synonym, and acquires a standard notation. Then, from search data, the search device searches for document data having a word serving as a keyword and words matching with word-group data including a standard notation thereof, and then outputs search results.

In this way, the search device disclosed in Patent Document 1 searches document data including single words related to the single word included in the search conditions of the user such as different notation, variant character, equivalent term and synonym.

Patent Document 1: Japanese Unexamined Patent Application, Publication No. 2004-86307

### DISCLOSURE OF THE INVENTION

### Problems to be Solved by the Invention

However, in recent years, despite an efficient and accurate search having been demanded even in a case of a search term of a long sentence being inputted in multiple languages, the current situation is that it is difficult to meet such demands with conventional search devices, including Patent Document 1.

The present invention has been made by taking such a situation into account, and has an object of making the efficient and accurate searches feasible, even in the case of a search term of long text being inputted in multiple languages.

### Means for Solving the Problems

In order to achieve the above-mentioned object, according to an aspect of the present invention

a search device for outputting a search result denoted in a second system of symbols based on a search request denoted in a first system of symbols, includes:

an input means for inputting a search request denoted in the first system of symbols from a user;

a conversion means for converting the search request denoted in the first system of symbols inputted by way of the input means into a signifying language differing from the first system of symbols; and

a search means for executing a search using the search request in the signifying language converted by the conversion means, and outputting a search result denoted in the second system of symbols.

In this case,

the search means can

set, as a search target, a dictionary system in which a plurality of indices specified in the signifying language is assigned, and storing illustrations associated with each of the plurality of indices as the second system of symbols; and output an illustration corresponding an index hit by the search request in the signifying language, among the plurality of indices.

In addition, the search means can:

include a storage unit that stores at least one simple term dictionary unit configured to include a simple term in the signifying language, and a complex term dictionary unit configured to include one of the simple terms constituting the simple term dictionary unit, by attaching a unique identifier to the simple term dictionary unit and the complex term dictionary unit, respectively, and set, as a search target, a dictionary system wherein each simple term constituting the complex term is referenced via the identifier to the simple term dictionary unit; and execute a search using a search request in the signifying language, and output a search result denoted in the second system of symbols.

Each of the search methods and programs according to an aspect of the present invention are methods and programs corresponding to the aforementioned search device according to an aspect of the present invention.

### Effects of the Invention

According to the present invention, it is possible to realize an efficient and accurate search, even in the case of a search term of a long sentence being inputted in multiple languages.

### BRIEF DESCRIPTION OF THE DRAWINGS

FIG. 1 is a view showing an overall configuration of a system according to one example of a preferred embodiment of the present invention;

FIG. 2 is a view showing an example of hardware configurations of a server and a terminal of the system of FIG. 1;

FIG. 3 is a functional block diagram showing the functional configuration for executing search processing, among the functional configurations of the server of the system in FIG. 1;

FIG. 4 is a schematic diagram showing an example of execution results of the search processing by the server of the functional configuration in FIG. 3;

FIG. 5 is a view showing the constitution of a term in a dictionary system to which the dial lock method is applied;

FIG. 6 is a view showing a dictionary unit in the dictionary system to which the dial lock method is applied;

FIG. 7 is a view showing a data structure of a simple term in the dictionary system to which the dial lock method is applied;

FIG. 8 is a view showing the data structure of a complex term in the dictionary system to which the dial lock method is applied;

FIG. 9 is the overall structure of the dictionary in the dictionary system to which the dial lock method is applied;

FIG. 10 is a view showing a reference in the dictionary system to which the dial lock method is applied;

FIG. 11 is a view showing combination in the dictionary system to which the dial lock method is applied;

FIG. 12 is a view showing reconfiguration of the dictionary system to which the dial lock method is applied;

FIG. 13 is a view showing an example of a general search in the case of receiving input of a search request term in the dictionary system to which the dial lock method is applied;

FIG. 14 is a view showing an example of a general search in the case of receiving input of a search request term in the dictionary system to which the dial lock method is applied;

FIG. 15 is a view showing an example of a general search in the case of receiving input of a search request term in the dictionary system to which the dial lock method is applied;

FIG. 16 is a view showing an example of a general search in the case of receiving input of a search request term in the dictionary system to which a dial lock method is applied;

FIG. 17 is a view showing an example of a general search in the case of receiving input of a search request term in the dictionary system to which the dial lock method is applied;

FIG. 18 is a view showing the processing of reconfiguration of a dictionary in the case of a new association between complex terms being given in the dictionary system to which the dial lock method is applied;

FIG. 19 is a view showing the processing of reconfiguration of a dictionary in the case of a new association between complex terms being given in the dictionary system to which the dial lock method is applied;

FIG. 20 is a view showing the processing of reconfiguration of a dictionary in the case of a new association between complex terms being given in the dictionary system to which the dial lock method is applied;

FIG. 21 is a view showing the processing of reconfiguration of a dictionary in the case of a new association between complex terms being given in the dictionary system to which the dial lock method is applied;

FIG. 22 is a view showing the processing of reconfiguration of a dictionary in the case of a new association between complex terms being given in the dictionary system to which the dial lock method is applied;

FIG. 23 is a view showing division in the dictionary system to which the dial lock method is applied;

FIG. 24 is a flowchart illustrating the flow of search processing executed by a server of the functional configuration in FIG. 3;

FIG. 25 is a view showing an example of an index assigned to each search target;

FIG. 26 is a view showing an example of search results in the case of an index reverse-search being performed;

FIG. 27 is a view showing an example of dictionary units in the case of applying the dial lock method to an index reverse search;

FIG. 28 is a view showing a structure example of the illustration dictionary system of FIG. 3, in the case of applying the dial lock method and index reverse search to a search with the search target of an illustration group;

FIG. 29 is a view showing an example created by further adding indices to the index of the dial lock dictionary of the example in FIG. 28;

FIG. 30 is a schematic diagram showing an example of an outline of a search system applying signifying language internal processing;

FIG. 31 is a schematic diagram showing an example of an outline of a search system applying signifying language internal processing, which is an example differing from FIG. 30;

FIG. 32 is a view showing an example of a dial lock dictionary;

FIG. 33 is a view showing a specific example of search results in the case of applying the dial lock method to signifying language internal processing; and

FIG. 34 is a view showing an example of an English dial lock dictionary.

### PREFERRED MODE FOR CARRYING OUT THE INVENTION

Hereinafter, embodiments of the present invention will be explained while referencing the drawings.

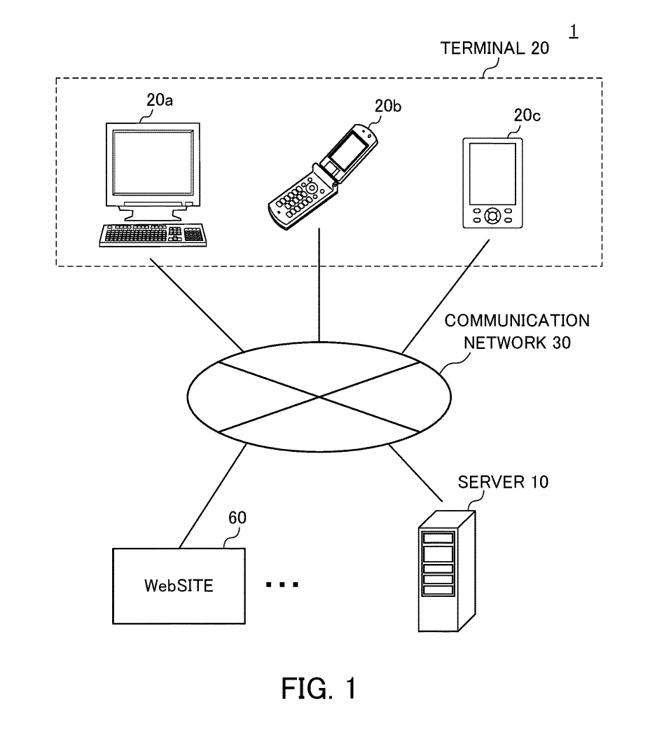

FIG. 1 is a view showing an overall configuration of a system 1 according to an example of a preferred embodiment of the present invention.

The system 1 of the present embodiment is configured so as to include a server 10, terminal 20, and Website 60. The server 10, terminal 20 and Website 60 are mutually connected via a predetermined communication network 30, including the Internet.

The server 10 receives or collects, and stores document data including text, images, etc. (e.g., Webpage on Internet or Internet). The server 10 analyzes the document data, extracts term data, and stores in a dictionary system.

The server 10 executes a search using term data in the dictionary system in response to a search request character string via the terminal 20 from a user, and presents the search results thereof to the user via the terminal 20.

Herein, “search using term data in dictionary system” refers to a search that is not particularly limited in regards to the purpose for which term data is used, timing, technique, or the like, so long as using the term data in the dictionary system.

More specifically, for example, matching of a “comparison targets” relative to a “comparison source” is performed, and there is a relationship in which predetermined terms, etc. are searched based on this matching result, i.e. relationship of matching “comparison source”->“comparison targets”. In addition, the search request character string is justifiable even for term units such as a single word; however, a search request of a sentence unit shall be made hereinafter. It should be noted that the search request character string of a sentence unit is called “search request sentence” hereinafter.

In this case, in a general dictionary system, the search request sentence is the “comparison source”, and the indices of the dictionary system are the “comparison targets”. In other words, in a general dictionary system, matching of search request sentence->index of dictionary system is performed. That is, an index that is dismantled into elements such as a plurality of words from the search request sentence by way of predetermined processing such as morphological analysis (hereinafter dismantled terms are called “dismantled search elements”), and matching with the dismantled search elements is hit. Such a search is called “general search” hereinafter. The general search is also included in “search using term data in dictionary system”, as a matter of course.

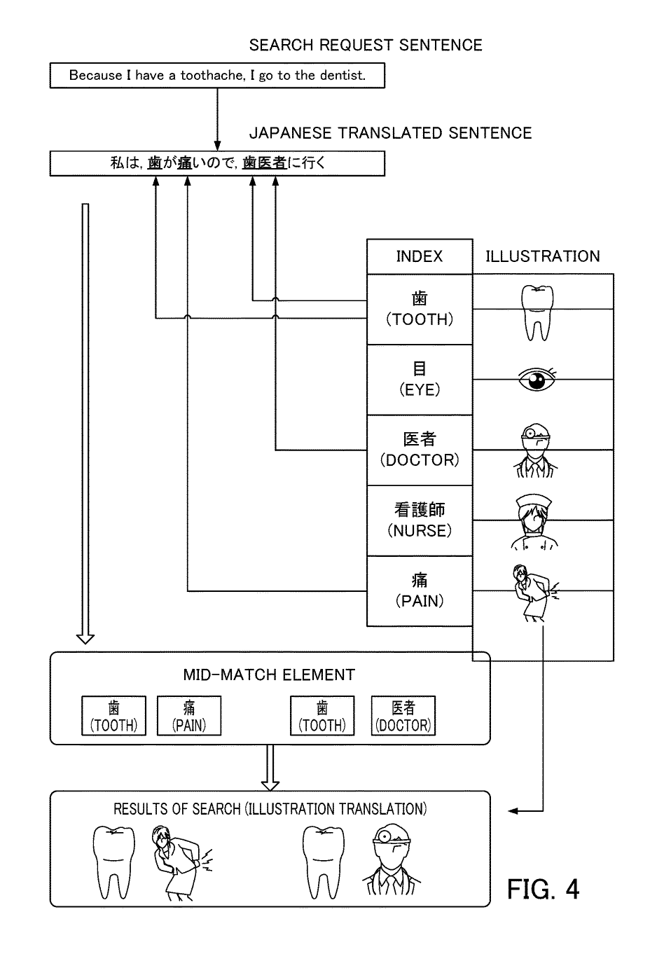

Furthermore, with the dictionary system of the present embodiment, there are also cases where the indices of the dictionary system are the “comparison source”, and the search request sentence is the “comparison targets”. In other words, with the dictionary system of the present embodiment, index of dictionary system->search request sentence matching is performed. In this case, the search request sentence comes to hit the predetermined index, in the case of an element mid-matching with a predetermined index (partial match) being included within the search request sentence. Such a search is called “index reverse search” hereinafter. This “index reverse search” is also included in the “search using term data in dictionary system”. Further details of the index reverse search will be described later using FIG. 4, etc.

Furthermore, the server 10 can also search illustrations described later, documents managed by the Website 60, and the like, based on the index of a hit target (index hit in a general search, index hitting the search request sentence in an index reverse search). Such a search is also included in the “search using term data in dictionary system”.

The Website 60 stores document data (e.g., Webpage data), and sends this document data to the server 10 and terminal 20 through the communication network 30. It should be noted that, herein, Website 60 refers to a Webpage data group such as a personal or company home page, or a location on the Internet managing a Webpage data group.

The communication network 30 connects the server 10, Website 60 and terminal 20. Herein, the communication network 30 is not only realized by wire, but may be realized by various communication networks so long as conforming with the technical concept of the present invention, such as networks realizing a portion by wireless via base stations as in mobile telephones, etc., and networks realized by way of wireless LAN via an access point.

Other than a desktop PC (Personal Computer) 20a, for example, the terminal 20 is configured by communication terminals that are portable such as a mobile telephone 20b and smartphone 20c.

It should be noted that the system 1 may be configured so as collectively execute information processing by way of software described later in the terminal 20, and to exhibit all the functions as a stand-alone system. In addition, the system 1 realized as a stand-alone system in the terminal 20 may further include documents and symbols serving as search targets, and may configure a management device with a search function or normalizing function. Alternatively, the system 1 may be configured as documentation by combining software and documents or symbols serving as search targets.

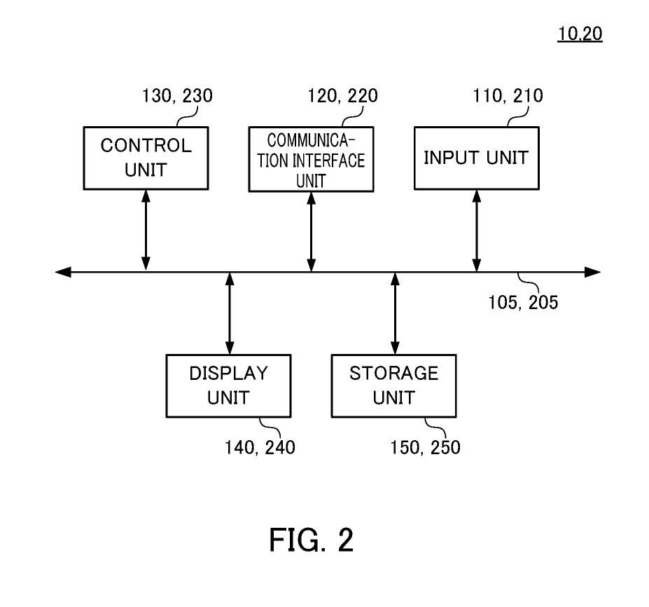

FIG. 2 is a view showing an example of hardware configurations of the server 10 and terminal 20 in the system 1 of FIG. 1.

As shown in FIG. 2, the server 10 includes an input unit 110, communication interface unit 120, control unit 130, display unit 140 and storage unit 150. The input unit 110 to storage unit 150 are connected with each other by a bus line 105.

The input unit 110 is configured by input devices such as a mouse and keyboard, for example.

The communication interface unit 120 is configured by a LAN adapter, modem adapter or the like, for example.

The control unit 130 is configured by a CPU (Central Processing Unit), for example, controls the server 10 overall, and executes various processing described later by way of reading and executing programs stored in the storage unit 150, for example.

The display unit 140 is configured by a liquid crystal display device (LCD), cathode-ray tube display device (CRT), or the like.

The storage unit 150 is configured by a hard disk, semiconductor memory, or the like.

It should be noted that it is also possible to install a program of the server 10 onto a separate computer, and cause this computer to function as a server device. In other words, the entirety or a part of the functions realized by the server 10 explained as an embodiment of the present invention are realizable by a separate computer.

The terminal 20 has a similar configuration to the server 10 in the present embodiment. In other words, as shown in FIG. 2, the terminal 20 includes an input unit 210, communication interface unit 220, control unit 230, display unit 240 and storage unit 250.

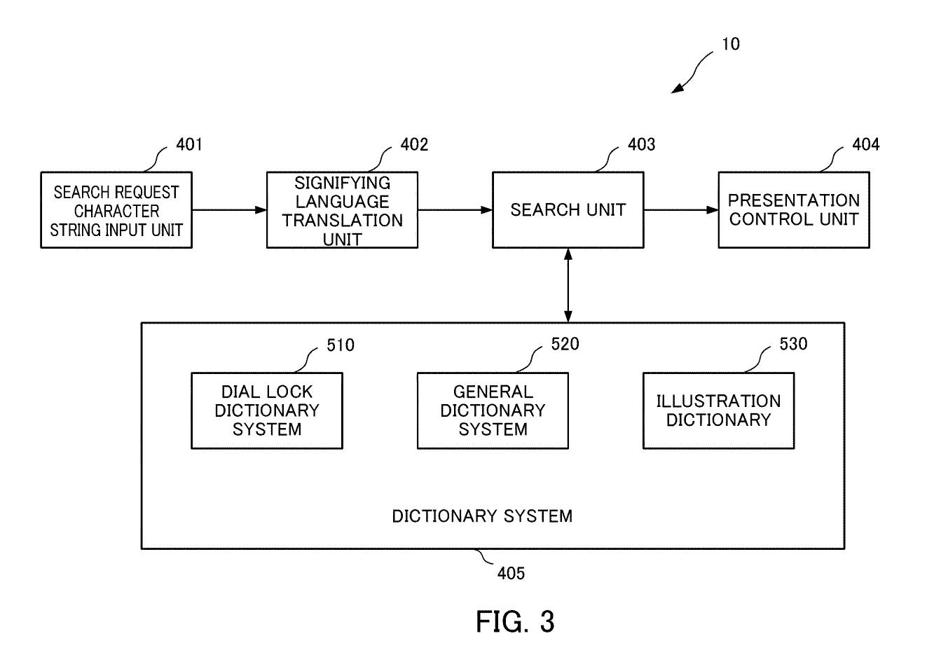

FIG. 3 is a functional block diagram showing a functional configuration for executing search processing, among the functional configurations of the server 10 in such a system 1.

Search processing refers to processing in response to a search request character string inputted via the terminal 20 by the user, for example, until executing the searching using term data in the dictionary system, and presenting the search results thereof to the user via the terminal 20. Herein, the form of the search results are not particularly limited as mentioned above, and an illustration showing the semantic content of the search request character string is adopted in the example of FIG. 3.

In the case of the search processing being executed in the control unit 130 (FIG. 2), etc. of the server 10, the search request character string input unit 401, signifying language translation unit 402, search unit 403, presentation control unit 404 and dictionary system 405 all function.

The dictionary system 405 includes a dial lock dictionary system 510, general dictionary system 520, and illustration dictionary system 530.

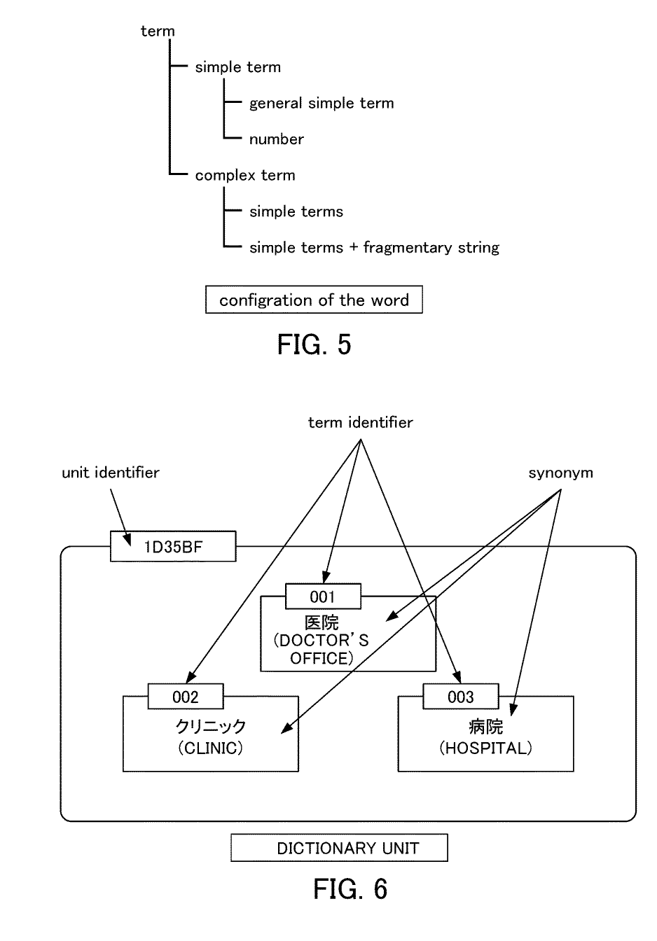

The dial lock dictionary system 510 is a dictionary system to which the dial lock method is applied. Dial lock method is a method invented by the present inventors, and is described in Japanese Patent No. 5161891. The details of the dial lock method are described later by referencing FIGS. 5 to 23.

The general dictionary system 520 is a dictionary system to which any method other than the dial lock method is applied.

Therefore, the dictionary system 405 does not particularly require simultaneously including the dial lock dictionary system 510 and the general dictionary system 520, and may include either one. However, as described later, the dictionary system 405 more suitably includes the dial lock dictionary system 510.

The illustration dictionary system 530 refers to a dictionary system in which illustrations corresponding to each of the respective elements (word, phrase, etc.) of a predetermined language (Japanese in the present embodiment) are stored. It should be noted that the format of the illustration dictionary system 530 is not particularly limited, and can also easily adopt the dial lock method.

FIG. 4 is a schematic diagram showing an example of execution results of search processing by way of the server 10 with the functional configuration of FIG. 3.

Therefore, the functional configuration of the server 10 shown in FIG. 3 will be explained while referencing FIG. 4 as appropriate, hereinafter.

The user can input the search request character string of desired semantic content by operating the terminal 20.

The unit of the search request character string is not particularly limited, and is not an issue even if units of words or clauses, for example; however, it shall be the units of a sentence herein. In other words, the user shall input the search request sentence by operating the terminal 20.

In addition, the language of the search request sentence is not particularly limited; however, in order to emphasize the superiority of the present invention, herein, it shall be a language other than a signifying language, e.g., English.

More specifically, for example, it shall be inputted to the terminal 20 with “Because I have a toothache, I go to the dentist.” shown in FIG. 4 as the search request sentence.

This search request sentence is transmitted to the server 10 via the communication network 30 from the terminal 20. The search request character string input unit 401 of the server 10 inputs the search request term, and supplies to the signifying language translation unit 402.

The signifying language translation unit 402 translates the search request sentence of a language other than a signifying language (herein, English) into a predetermined signifying language. The signifying language is not particularly limited; however, it shall be Japanese herein.

More specifically, for example, the search request sentence in English of “Because I have a toothache, I go to the dentist.” shown in FIG. 4 is converted into the Japanese sentence (hereinafter called “translated Japanese search request sentence”) of “ [symbol] [symbol] [symbol] (Because I have a toothache, I go to the dentist in Japanese)”.

Herein, the translated Japanese search request sentence is used in the internal processing of the search, and is not presented to the user. This is because, compared to languages other than signifying languages (English, etc.), a signifying language such as Japanese is suitable when used in the internal processing of searching, particularly in the internal processing in the case of searching symbols such as illustrations as in the present embodiment. The reasons for being suitable will be described later.

The search unit 403 executes a search using the term data in the dictionary system 405 according to the translated Japanese search request sentence, and provides the search results to the presentation control unit 404.

The presentation control unit 404 presents the search results to the user via the terminal 20, by executing control to send the search results to the terminal 20 via the communication network 30 (FIG. 1).

Herein, in addition to “general search” in which the indices in the dictionary system 405 serve as the search target, the “index reverse search” with the translated Japanese search request sentence serving as the search target is also included in the “search using term data in dictionary system 405”.

Therefore, each of the “general search” and “index reverse search” included in the “search using term data in dictionary system 405” will be specifically explained hereinafter.

As a prerequisite, the illustration dictionary system 530 of the example in FIG. 4 shall be used. In the illustration dictionary system 530 of the example in FIG. 4, an index shall be assigned in advance to each of the plurality of illustrations. In each index, one term in Japanese (single-character word, etc.) indicating the meaning of the corresponding illustration is included as an index term.

In other words, in the illustration dictionary system 530, an illustration of “one tooth” is associated with the index of “tooth”. Similarly, an illustration of “one eye” is associated with the index of “eye”. An illustration of “doctor (man wearing white gown)” is associated with the index of “doctor”. An illustration of “nurse (woman wearing white gown)” is associated with the index of “nurse”. An illustration of “person with injured back” is associated with the index of “pain”.

The search unit 403 executes the following such series of processing as a general search.

In other words, the search unit 403 first dismantles the Japanese search request sentence of “ [symbol] [symbol] [symbol] [symbol] (Because I have a toothache, I go to the dentist in Japanese)” into a plurality of terms (elements), using a technique such as morphological analysis. For example, as a result of dismantling, the dismantled search elements of “ [symbol] ”, “ [symbol] ”, “ [symbol] (tooth in Japanese)”, “ [symbol] ”, “ [symbol] (ache in Japanese)”, “ [symbol] ”, “ [symbol] (dentist in Japanese)”, “ [symbol] ” and “ [symbol] (go in Japanese)” are obtained.

Next, the search unit 403 performs matching with each of these respective dismantled search elements as the comparison source, and each index of the illustration dictionary system 530 of the example in FIG. 4 as the comparison target, for example. Then, the search unit 403 causes an index matching with the comparison source to be hit, and extracts the illustration corresponding to the hit index as a search result, for example.

More specifically, among the plurality of dismantled search elements that were dismantled from the search target request sentence, only the dismantled search element of “ [symbol] (tooth in Japanese)” matches with the index of “tooth”. Therefore, only the illustration of “one tooth” is presented as a search result.

Herein, a major application of the system 1 assumed in the example of FIG. 4 is to achieve smooth communication between a user with English as their native language, and a third party who cannot understand English. In other words, the user employs the system 1 in the case of wanting to convey to the third party an English search request sentence, e.g., the semantic content of “Because I have a toothache, I go to the dentist.”

In such a case, even if only the illustration of “one tooth” is presented, it is difficult to convey to a third party the semantic content of “Because I have a toothache, I go to the dentist.”

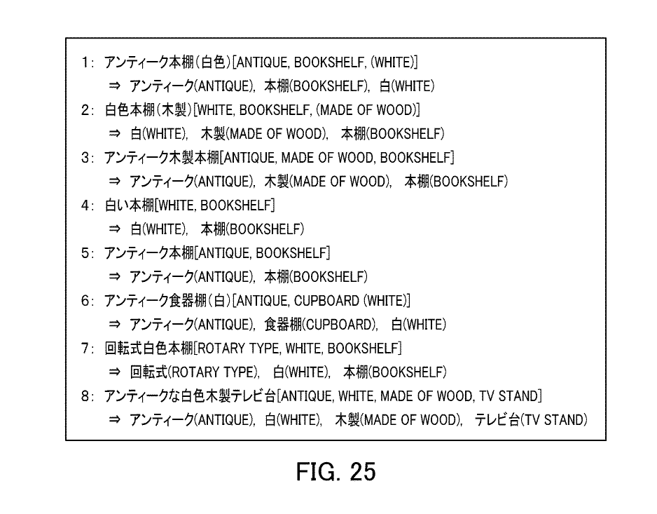

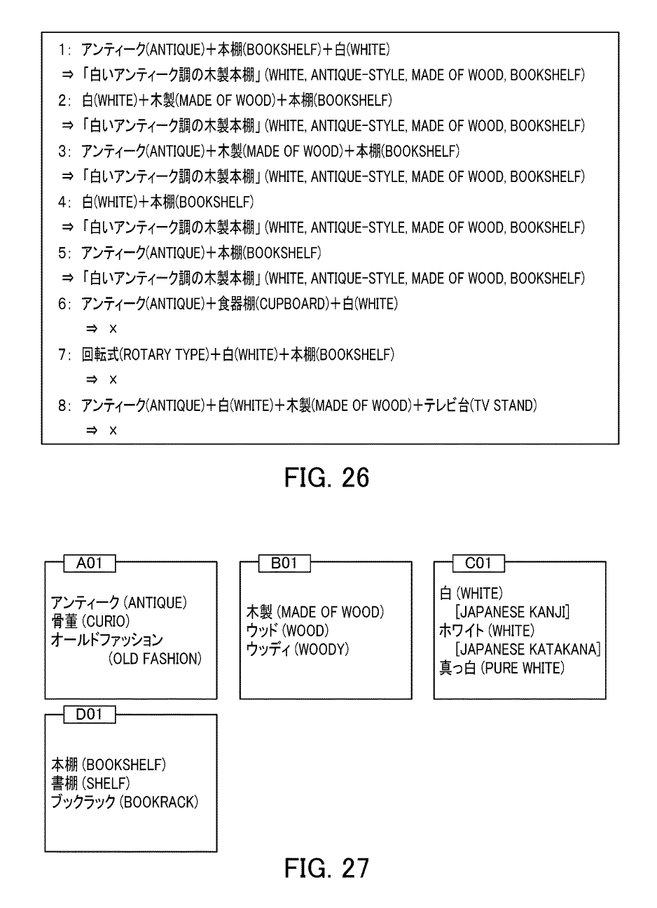

Naturally, it is possible to devise a technique such as morphological analysis to produce a large variety of dismantled search elements. For example, not only “ [symbol] (dentist in Japanese)”, but also “ [symbol] (doctor in Japanese)” can be created as a dismantled search element. However, by vainly creating dismantled search elements, inappropriate elements (elements that become so-called noise) tend to be searched, as described later by referencing FIGS. 25 and 26.

Therefore, in the present embodiment, the search unit 403 executes not only a general search, but also the following such index reverse search.

In other words, the search unit 403 sequentially sets each of the respective indices of the illustration dictionary system 530 in the example of FIG. 4, as the comparison source to take notice as the target of processing (hereinafter called “noted comparison source”).

The search unit 403 sets the translated Japanese search request sentence, e.g., “ [symbol] [symbol] [symbol] (Because I have a toothache, I go to the dentist in Japanese)” as the comparison partner.

The search unit 403 compares between the noted comparison source and the comparison partner, and in the case of an element matching in the middle (partial match) with the noted comparison source existing in the comparison partner, the comparison partner is made to hit the noted comparison source. In other words, the mid-match element referred to herein differs from the dismantled search element of a general search, and is not dismantled from the translated Japanese search request sentence serving as the comparison partner. In other words, in the general search, although the index hits the dismantled search element, in the index reverse search, the translated Japanese search request sentence of the comparison partner hits the index of the noted comparison source.

For an index (noted comparison source) hitting the translated Japanese search request sentence (comparison partner), the search unit 403 extracts an illustration corresponding to this index (noted comparison source) as the search result.

The detection unit 403 executes an index reverse search by sequentially setting each of the respective indices of the illustration dictionary system 530 of the example in FIG. 4, and repeatedly executing the above series of processing.

In the index reverse search of the example in FIG. 4, among the translated Japanese search request sentence, “ [symbol] (tooth in Japanese)”, “ [symbol] (ache in Japanese)”, “ [symbol] (tooth in Japanese)” and “ [symbol] (doctor in Japanese)” serve as mid-match elements.

Herein, in the example of FIG. 4, although the mid-match elements are illustrated to be separated to make understanding of the present invention easy, actually, the search results are not outputted by the mid-match elements being used, but rather the search results are outputted by the index matching with the mid-match elements being used (index hitting the translated Japanese search request sentence).

In other words, the respective indices of “ [symbol] (tooth in Japanese)”, “ [symbol] (ache in Japanese)”, “ [symbol] (tooth in Japanese)” and “ [symbol] (doctor in Japanese)” are used, and the illustration group such as that shown in FIG. 4 is suggested as the search result. More specifically, as the search result, the illustration of “one tooth”, the illustration of “person with back pain”, the illustration of “one tooth”, and the illustration of “doctor (man wearing gown)” are suggested.

It is thereby possible for a third party to understand the semantic content of “toothache” from the combination of the illustration of “one tooth” and the illustration of “person with back pain”, even if not able to understand English, and further understand the semantic content of “dentist” from the combination of the illustration of “one tooth” and the illustration of “doctor”.

In other words, it is possible for a third party to assume with a certain level of accuracy the semantic content of the English search request sentence of “Because I have a toothache, I go to the dentist”, based on the semantic content of “toothache” and “dentist”.

Next, a suitable dial lock method to apply to a dictionary system will be explained by referencing FIGS. 5 to 23. In the present embodiment, the dial lock method is applied to the dial lock dictionary system 510, and is also applicable to the illustration dictionary system 530 described later.

FIG. 5 is a view showing the constitution of terms in the dictionary system to which the dial lock method is applied.

A cohesive character string constituting the dictionary is referred to as “term”. In a term, there is a simple term and a complex term. All terms become a registration target of the present dictionary system.

Herein, since divisible terms are not included in the dictionary in the present dictionary system, a simple term is a term for which further division is not possible. More specifically, for example, there are “ [symbol] (dog in Japanese kanji”, “ [symbol] (dog in Japanese katakana)”, “ [symbol] (cat in Japanese kanji)”, “ [symbol] (cat in Japanese katakana)”, “ [symbol] (doctor's office in Japanese)”, “ [symbol] (clinic in Japanese)”, etc. Numbers are handled as unique simple terms. More specifically, for example, there are “123”, “123, 456”, etc.

In addition, a complex term refers to linked terms of at least one simple term or a simple term and an incomplete term character string (fragmentary string; character string not registered as term). Distinguishing between these simple terms and complex terms depends on the dictionary management as described later, with simple terms simply becoming a complex term, and a complex term simply becoming simple terms.

FIG. 6 is a view showing dictionary units of the dictionary system to which the dial lock method is applied.

The dictionary unit is configured to include at least one term. All dictionary units correspond to a unit identifier, and the dictionary unit is referenced from outside with the unit identifier as a pointer, as described later.

Herein, dictionary unit is also called “dial” as appropriate below.

The terms constituting the dictionary unit denote being in the relationship of synonyms with each other. In this example, “ [symbol] (doctor's office in Japanese)”, “ [symbol] (clinic in Japanese)” and “ [symbol] (hospital in Japanese)”, which are terms included in the dictionary unit corresponding to the unit identifier “1D35BF”, are defined as synonyms to each other. In addition, each term corresponds to a term identifier. In other words, in this example, “ [symbol] (doctor's office in Japanese)” corresponds to the term identifier of “001”, “ [symbol] (clinic in Japanese)” to “002” and “ [symbol] (hospital in Japanese)” to “3003”, and are referenced from outside as pointers. For example, the term of “ [symbol] (doctor's office in Japanese)” can be referenced with the pointer constituted by the unit identifier and term identifier of “1D35BF” and “001”.

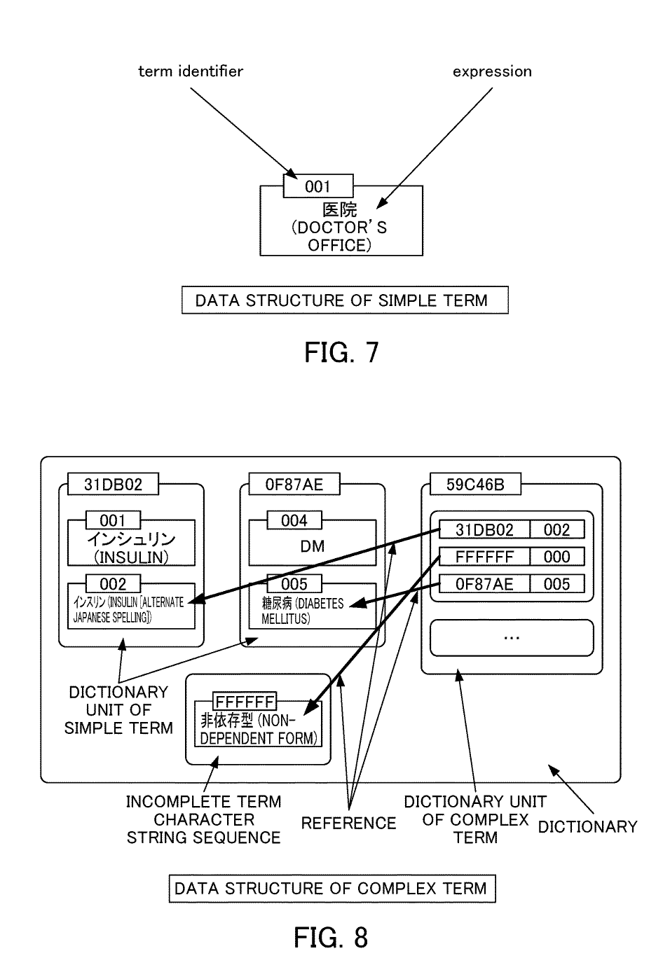

FIG. 7 is a view showing the data structure of simple terms in the dictionary system to which the dial lock method is applied.

Due to divisible terms not being included in the dictionary system as mentioned above, the simple term is a term for which further division is not possible. With this example, the simple term “ [symbol] (doctor's office)” denote being identified with the term identifier “001” as the pointer.

FIG. 8 is a view showing the data structure of complex terms in the dictionary system to which the dial lock method is applied.

With this example, the “complex term” referenced from outside with the unit identifier “59C46B” as the pointer is defined to include the sequence of identifiers configured to include the unit identifiers and term identifiers of “31DB02 (002)+FFFFFF (000)+0F87AE (005)”. Furthermore, the simple term dictionary unit referenced by the unit identifier of “31DB02” is configured to include “ [symbol] (insulin in Japanese)” further referenced by the term identifier “001”, and “ [symbol] (insulin in alternate Japanese spelling)” further referenced by the term identifier “002”. In other words, these are defined as synonyms. In addition, the incomplete term character string sequence “non-dependent form” referenced by the unit identifier “FFFFFF” is defined. Similarly, the simple term dictionary unit referenced by the unit identifier “0F87AE” is configured to include “DM”, which is further referenced by the term identifier “004”, and “ [symbol] (diabetes mellitus in Japanese)” which is further referenced by the term identifier “005”. With this example, the complex term of “ [symbol] [symbol] [symbol] (insulin non-dependent diabetes mellitus in Japanese)” is defined by these definitions.

By configuring in this way, the matter of synonyms of “ [symbol] [symbol] DM (insulin non-dependent DM in Japanese)”, “ [symbol] [symbol] [symbol] (insulin non-dependent diabetes mellitus in alternate Japanese spelling)” and “ [symbol] [symbol] DM (insulin non-dependent DM in alternate Japanese spelling)” existing as described later is defined as in the complex term of “ [symbol] [symbol] (insulin non-dependent diabetes mellitus in Japanese)”, which is referenced by the unit identifier “59C46B”, and can be used during search.

In other words, by using the unit identifier “59C46B” in the index, not only the complex term of “ [symbol] [symbol] (insulin non-dependent diabetes mellitus in Japanese)”, but also the synonyms of “ [symbol] [symbol] DM (insulin non-dependent DM in Japanese)”, “ [symbol] [symbol] (insulin non-dependent diabetes mellitus in alternate Japanese spelling)” and “ [symbol] [symbol] DM (insulin non-dependent DM in alternate Japanese spelling)” can be made to hit in the general search.

In addition, with the index reverse search, by setting the unit identifier “59C46B” as the noted comparison source, it is possible to make hit the search request sentence including not only the complex term of “ [symbol] [symbol] (insulin non-dependent diabetes mellitus in Japanese)”, but also at least one among the synonyms of “ [symbol] [symbol] DM (insulin non-dependent DM in Japanese)”, “ [symbol] [symbol] [symbol] (insulin non-dependent diabetes mellitus in alternate Japanese spelling)” and “ [symbol] [symbol] DM (insulin non-dependent DM in alternate Japanese spelling)” as an element.

By applying the dial lock method in this way, it is possible to easily realize a broad search also including similar scopes.

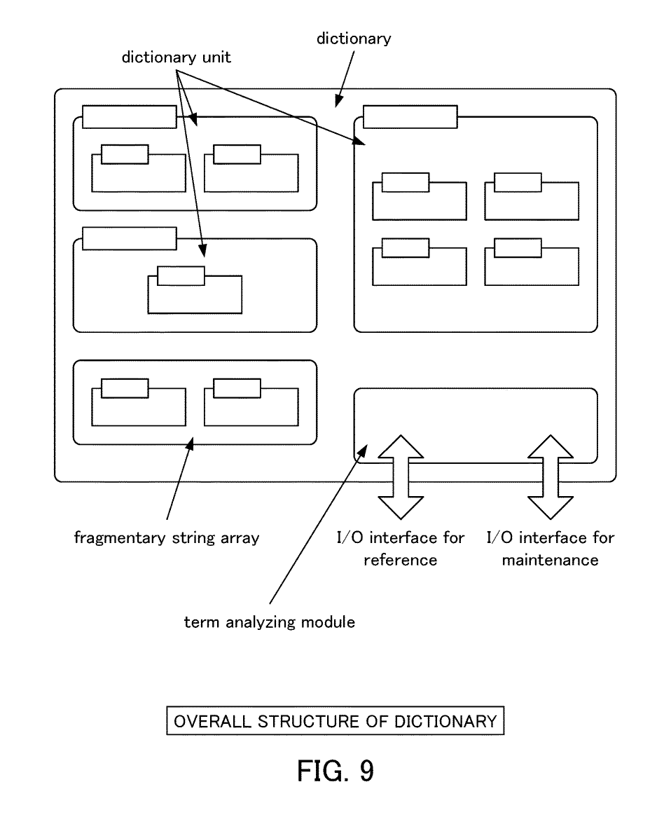

FIG. 9 is a view showing an overall structure of the dictionary in the dictionary system to which the dial lock method is applied.

In other words, in the present embodiment, the dial lock dictionary system 510 shown in FIG. 3 has the structure shown in FIG. 9. In addition, in the case of the dial lock method being applied to the illustration dictionary system 530, this illustration dictionary system 530 comes to have the structure shown in FIG. 9.

As mentioned above, the dictionary system is configured to include dictionary units and incomplete term character string sequences, and is configured to include a term analyzing unit (term analyzing module) that is configured to include reference inputs/outputs (I/O interface for reference) and maintenance inputs/outputs (I/O interface for maintenance).

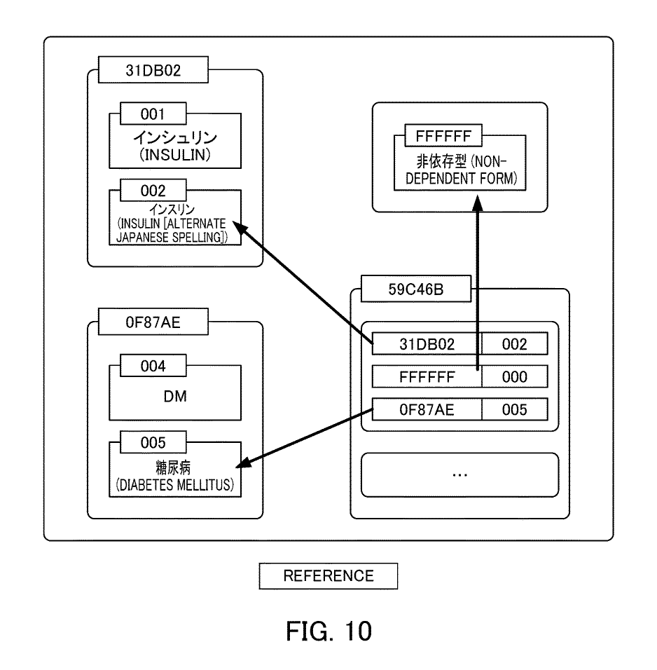

FIG. 10 is a view showing a reference in the dictionary system to which the dial lock method is applied. As mentioned above, in this example, a reference to the term of “ [symbol] [symbol] (insulin non-dependent diabetes mellitus in Japanese)” is shown.

By configuring so as to include the unit identifier “59C46B” as the index, it is possible for the control unit 130 to cause “ [symbol] [symbol] (insulin non-dependent diabetes mellitus in Japanese)” directly referenced by the unit identifier “59C46B” to be hit, in the case of receiving “ [symbol] [symbol] [symbol] (insulin non-dependent diabetes mellitus in Japanese)” as the search request term in a general search, for example. Furthermore, the control unit 130 can cause the synonyms of “ [symbol] [symbol] DM (insulin non-dependent DM in Japanese)”, “ [symbol] [symbol] (insulin non-dependent diabetes mellitus in alternate Japanese spelling)” and “ [symbol] [symbol] DM (insulin non-dependent DM in alternate Japanese spelling)” to also be hit automatically. Furthermore, the control unit 130 can also cause terms created at by shifting the order of these simple terms to be hit.

Furthermore, the control unit 130 can cause “ [symbol] [symbol] (insulin non-dependent diabetes mellitus in Japanese)” and other synonyms to be hit, even in a case of receiving the synonym of “ [symbol] [symbol] (insulin non-dependent diabetes mellitus in alternate Japanese spelling)” as the search request term, for example, in a general search.

In addition, the control unit 130 can perform a search by sequentially setting each synonym of “ [symbol] [symbol] DM (insulin non-dependent DM in Japanese)”, “ [symbol] [symbol] [symbol] (insulin non-dependent diabetes mellitus in alternate Japanese spelling)” and “ [symbol] [symbol] DM (insulin non-dependent DM in alternate Japanese spelling)”, not only “ [symbol] [symbol] [symbol] (insulin non-dependent diabetes mellitus in Japanese)”, as the noted comparison source in an index reverse search.

Then, the control unit 130 can cause this translated Japanese search request sentence to hit, in the case of any one of the elements among “ [symbol] [symbol] DM (insulin non-dependent DM in Japanese)”, “ [symbol] [symbol] (insulin non-dependent diabetes mellitus in alternate Japanese spelling)” or “ [symbol] [symbol] DM (insulin non-dependent DM in alternate Japanese spelling)”, not only “ [symbol] [symbol] [symbol] (insulin non-dependent diabetes mellitus in Japanese)”, being present in the translated Japanese search request sentence serving as the search target.

Alternatively, also by using terms made by replacing in the sequence of unit identifiers of “31DB02+FFFFFF+0F87AE”, the control unit 130 can similarly execute general searches and index reverse searches.

In this way, it is possible to construct a dictionary system such that includes the unit identifier “59C46B” or the sequence of unit identifiers “31DB02+FFFFFF+0F87AE” in the index. As a result thereof, the control unit 130 can efficiently perform a search covering registered synonyms, without losing accuracy.

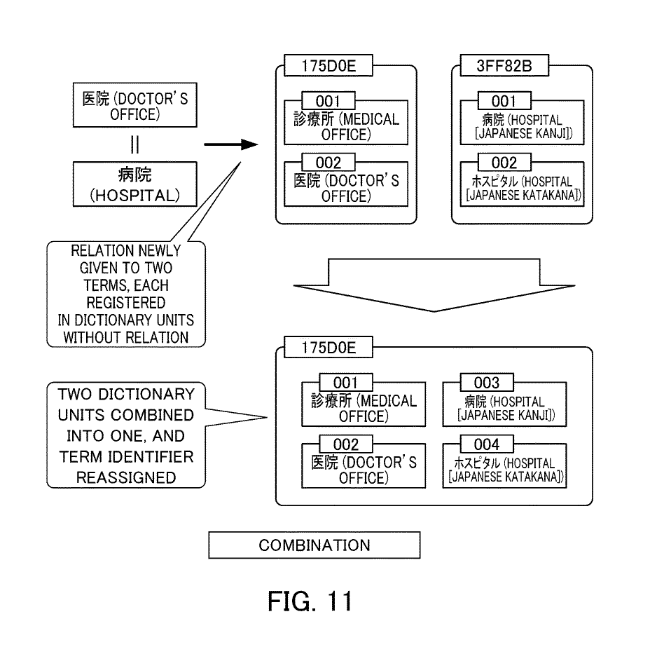

FIG. 11 is a view showing combination in the dictionary system to which the dial lock method is applied.

In this example, receiving data showing the association between “ [symbol] (doctor's office in Japanese)” and “ [symbol] (hospital in Japanese)”, the new dictionary unit “175D0E” is defined by integrating (combining) the dictionary units “175D0E” and “3FF82B” constituted by each term. In this case, each term identifier is newly reassigned.

Hereinafter, such a combination (integration) will be explained.

First, the terminal 20 inputs data indicating a new association of simple terms or complex terms, and sends to the server 10 via the communication network 30. It should be noted that the server 10 may directly input this data indicating a new association.

Next, based on each term included in the data showing the new association, the control unit 130 of the server 10 references the dictionary stored in the storage unit 150, and determines whether each term constitutes individual dictionary units from each other.

The control unit 130 of the server 10, in the case of the determination being true, combines the individual dictionary units. In the example of FIG. 11, “ [symbol] (doctor's office in Japanese)” and “ [symbol] (hospital in Japanese)” constitute the respective dictionary units of “175D0E” and “3FF82B”. Therefore, the control unit 130 combines both dictionary units “175D0E” and “3FF82B” in the new dictionary unit “175D0E”.

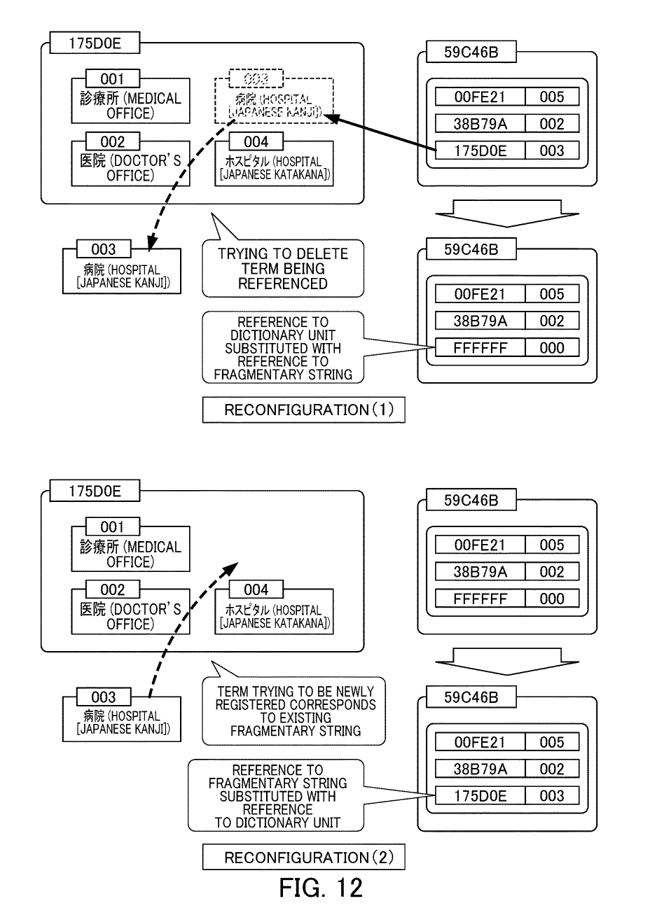

FIG. 12 is a view showing reconfiguration of a dictionary system to which the dial lock method is applied.

First, in the example of reconfiguration (1), “ [symbol] (hospital in Japanese)”, which is a simple term constituting a complex term associated with the unit identifier “59C46B”, is referenced with the unit identifier “175D0E” as the pointer, and further with the term identifier “003” as the pointer. Herein, in the case of the term “ [symbol] (hospital in Japanese)” being deleted from the dictionary unit of the unit identifier “175D0E” previously referenced, “ [symbol] (hospital in Japanese)” is no longer a term included in this dictionary unit, i.e. becomes an incomplete term character string. Therefore, the control unit 130 replaces the reference of the term “ [symbol] (hospital in Japanese)” from the reference “175D0E 003” to the reference “FFFFFF 000” of an incomplete term character string, for the complex term associated with the unit identifier “59C46B”.

In addition, in the example of reconfiguration (2), conversely to the above-mentioned example, upon “ [symbol] (hospital in Japanese)” referenced as the original incomplete term character string being registered as a new dictionary unit, the reference of the term “ [symbol] (hospital in Japanese)” in the complex term associated with the unit identifier “59C46B” is replaced from the reference “FFFFFF 000” to the incomplete term character string” with the reference “175D0E 003” to this dictionary unit.

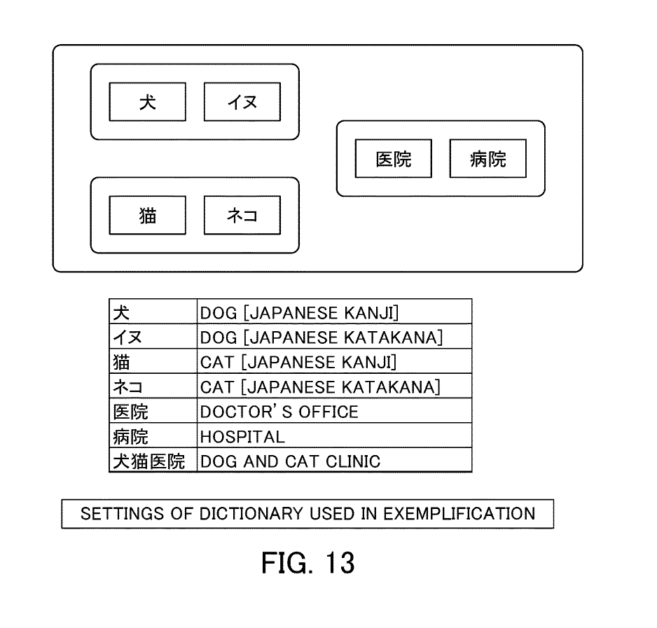

FIGS. 13 to 17 are views showing examples of general searches in the case of receiving the input of a search request term in the dictionary system to which the dial lock method is applied.

It should be noted that, in the present embodiment, the search candidate term itself may be used as the search result of the search unit 403 in FIG. 3. In addition, hereinafter, for convenience of explanation, an example of generation processing in the case of, not an index reverse search, but rather a general search being performed is shown.

First, as shown in FIG. 13, a case is considered of each of “ [symbol] (dog in Japanese kanji)” and “ [symbol] (dog in Japanese katakana)”, “ [symbol] (cat in Japanese kanji)” and “ [symbol] (cat in Japanese katakana)”, as well as “ [symbol] (doctor's office in Japanese)” and “ [symbol] (hospital in Japanese)” being set in three dictionary units.

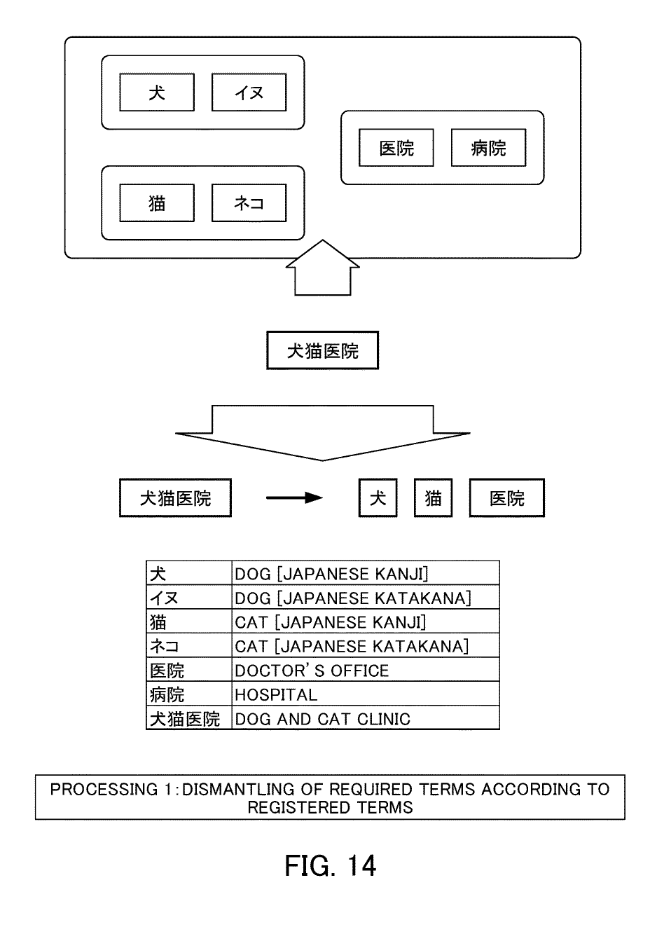

Herein, as shown in FIG. 14, in the case of “ [symbol] (dog and cat clinic in Japanese)” being given as the search request term (case of search request sentence including “ [symbol] (dog and cat clinic in Japanese)” being given), a case is considered of a general search in which the registered terms “ [symbol] (dog in Japanese kanji)”, “ [symbol] (cat in Japanese kanji)” and “ [symbol] [symbol] (doctor's office in Japanese)” are given as the indices, for example.

The control unit 130 dismantles the search request terms by an appropriate method into the dismantled search elements of “ [symbol] (dog in Japanese kanji)”, “ [symbol] (cat in Japanese kanji)” and “ [symbol] (doctor's office in Japanese)”, and causes the registered terms (indices) “ [symbol] (dog in Japanese kanji)”, “ [symbol] (cat in Japanese kanji)” and “ [symbol] (doctor's office in Japanese)” to be hit.

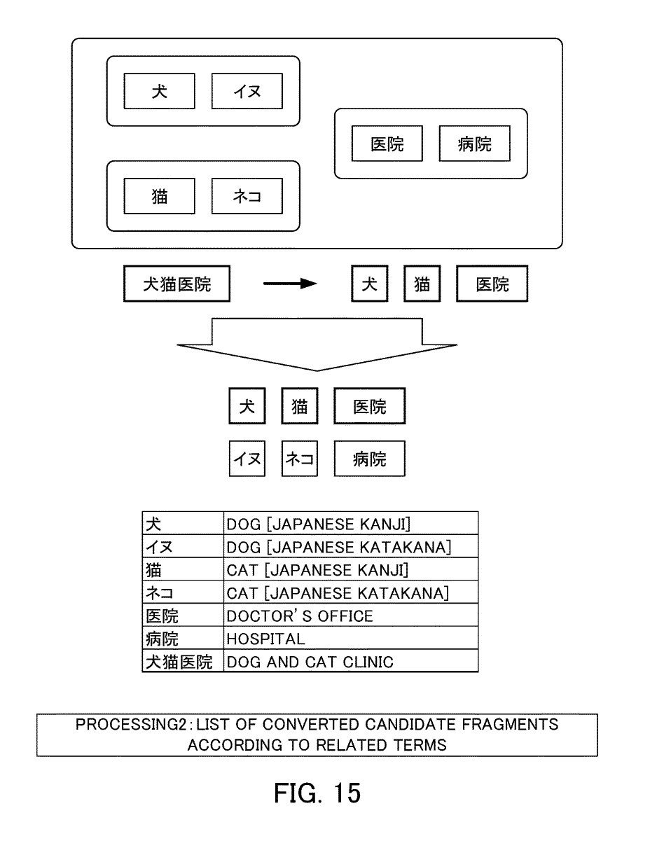

Next, as shown in FIG. 15, the control unit 130 references the dictionary units in which each registered term is included, and recognizes the “dog [Japanese katakana]” is a synonym to “dog [Japanese kanji]”, “cat [Japanese katana]” is a synonym to “cat [Japanese kanji]”, and “hospital” is a synonym to “doctor's office”.

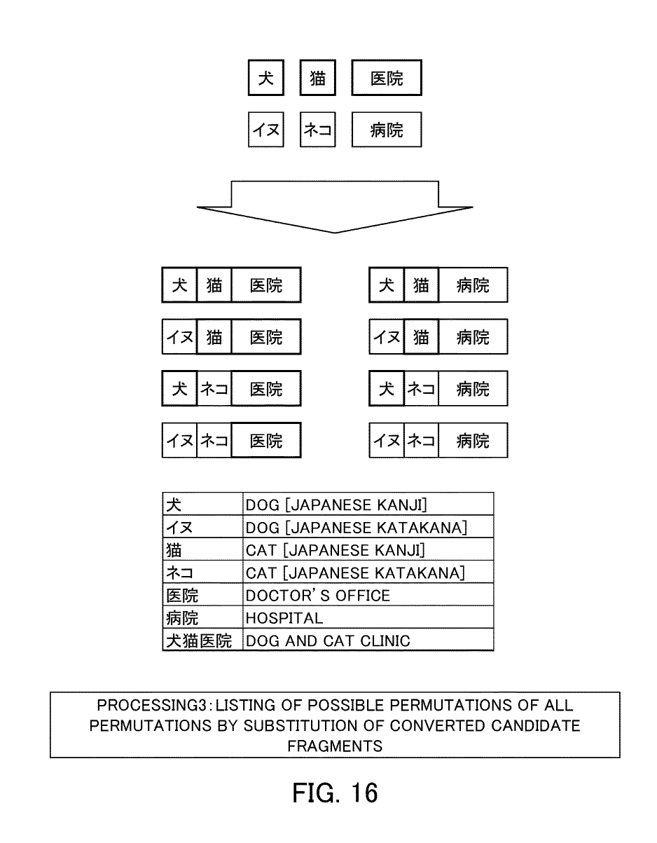

Next, the control unit 130 expands all permutations of these synonyms. In the case of this example, as shown in FIG. 16, it is expanded by 2×2×2 into 8.

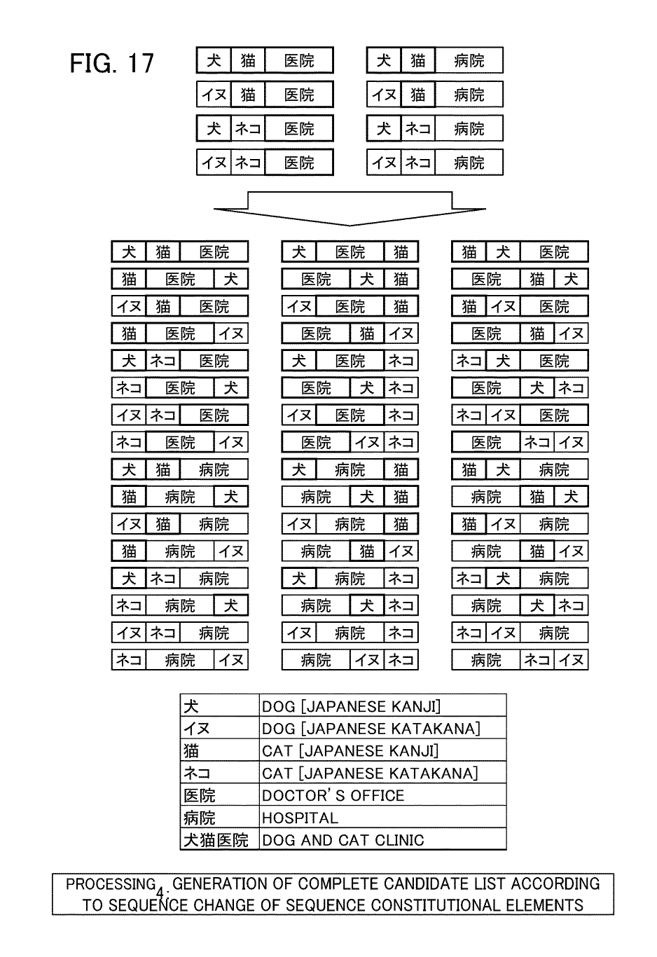

Next, as shown in FIG. 17, the control unit 130 further generates a complete candidate list by shifting the order of each permutation.

The control unit 130 outputs the search result based on the candidate list shown in FIG. 17. In other words, the control unit 130 may output a search result using the entire candidate list shown in FIG. 17, or may output a search result using a part of the candidate list shown in FIG. 17.

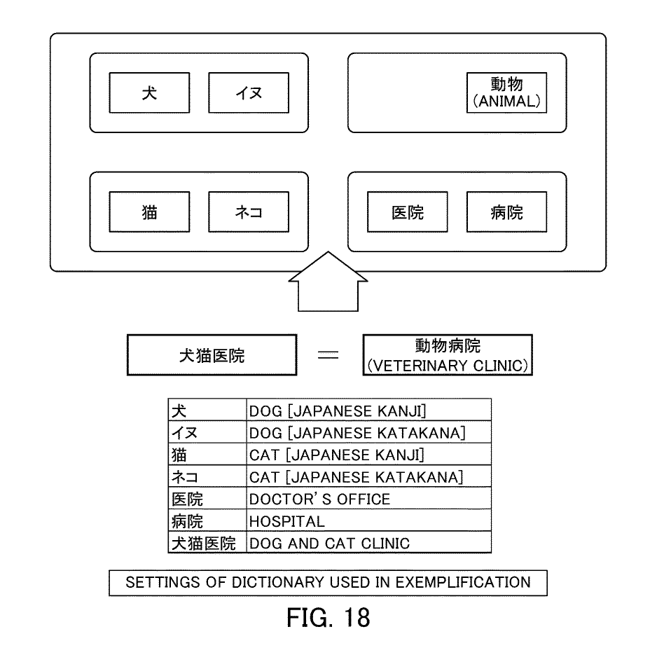

FIGS. 18 to 22 are views showing the processing of reconfiguration of the dictionary in the case of a new association between complex terms being given in the dictionary system to which the dial lock method is applied.

First, the terminal 20 inputs data showing the new association between complex terms, and sends to the server 10 via the communication network 30. It should be noted that the server 10 may directly input the data showing this new association.

Next, the control unit 130 of the server 10 determines whether a part of the complex term constitutes the same dictionary unit in the data showing this new association.

Next, in the case of this determination being true, the control unit 130 of the server 10 generates a new dictionary unit configured to include the simple terms or complex term constituting the remaining portion thereof. Hereinafter, an explanation will be provided using specific examples.

A case is considered of receiving data showing that the complex terms “ [symbol] (dog and cat clinic in Japanese)” and “ [symbol] [symbol] (veterinary clinic in Japanese)” are associated in a dictionary such as that shown in FIG. 18.

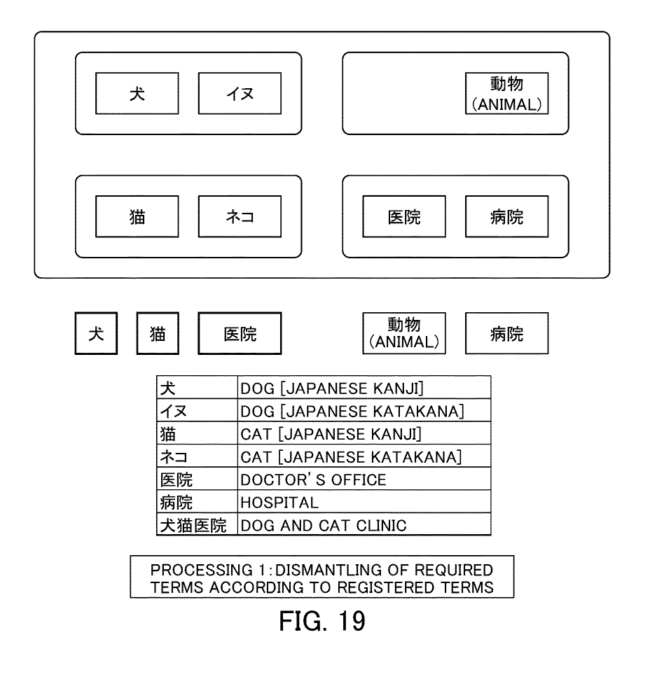

In this case, as shown in FIG. 19, the control unit 130 dismantles these two complex terms into the registered terms of “ [symbol] (dog in Japanese)”, “ [symbol] (cat in Japanese)”, “ [symbol] (doctor's office in Japanese)” and “ [symbol] (animal in Japanese)”, “ [symbol] (hospital in Japanese)”, respectively.

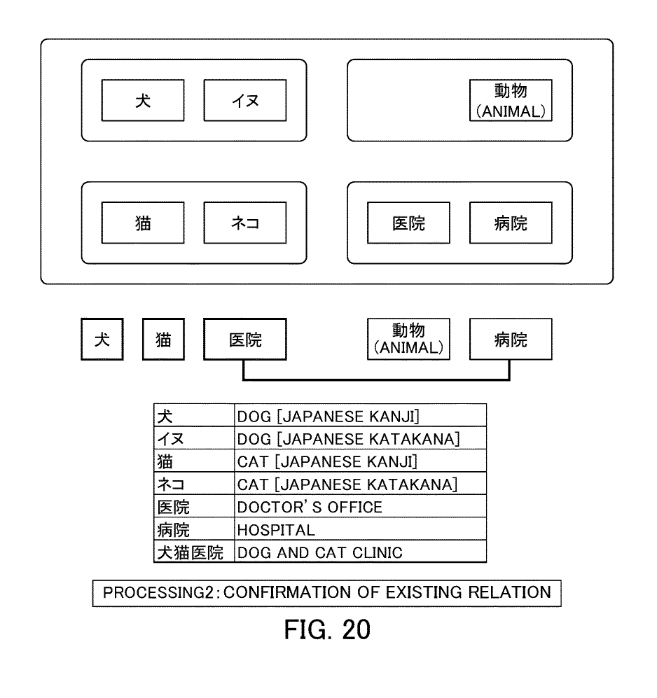

Next, as shown in FIG. 20, the control unit 130 confirms that “ [symbol] (doctor's office in Japanese)” and “ [symbol] (hospital in Japanese)” constitute the same dictionary unit.

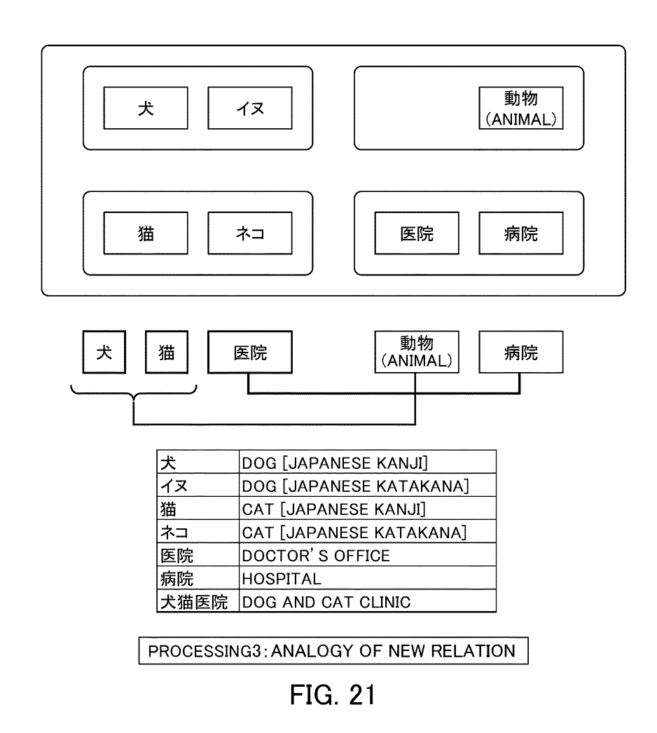

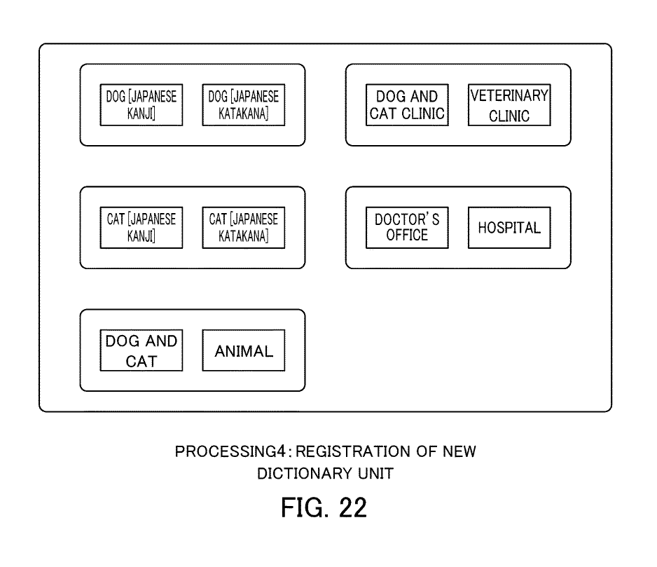

Next, as shown in FIG. 21, the control unit 130 registers “ [symbol] (dog in Japanese)”, “ [symbol] (cat in Japanese)” and “ [symbol] (animal in Japanese)”, which are the remaining portions, to constitute a new dictionary unit. More specifically, as shown in FIG. 22, the control unit 130 generates and registers a dictionary unit constituted by “ [symbol] (dog and cat in Japanese)” and “ [symbol] (animal in Japanese)”, and a dictionary unit constituted by “ [symbol] (dog and cat clinic in Japanese)” and “ [symbol] (veterinary clinic in Japanese)”.

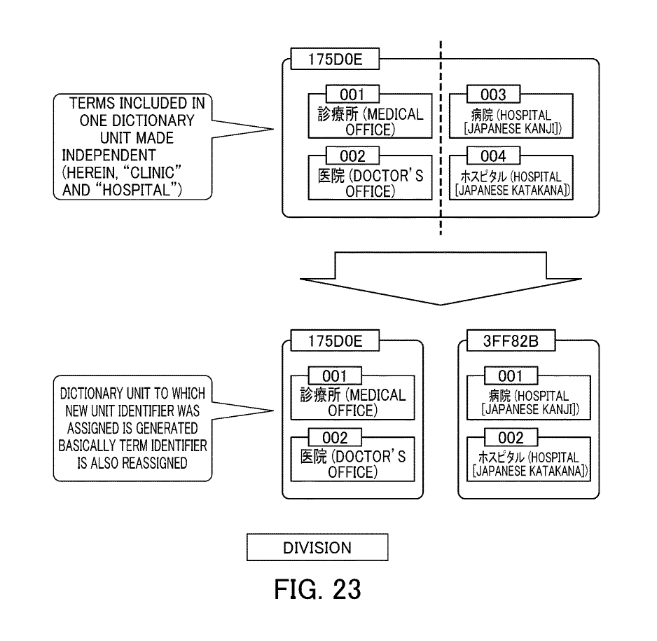

FIG. 23 is a view showing division in the dictionary system to which the dial lock method is applied.

In this example, the control unit 130 receives data showing to divide “ [symbol] (hospital in Japanese kanji)” and “ [symbol] [symbol] (hospital in Japanese katakana)” constituting the dictionary unit referenced with the same unit identifier “175D0E” as the pointer.

Next, the control unit 130 generates and registers a new dictionary unit configured to include “ [symbol] (hospital in Japanese kanji)” and “ [symbol] (hospital in Japanese katakana)” as the targets of this division, and references with the unit identifier “3FF82B” as the pointer.

The dial lock method is explained above by referencing FIGS. 5 to 23. For further details of the dial lock method, Japanese Patent No. 5161891 may be referenced.

Next, the flow of search processing executed by the server 10 with the functional configuration of FIG. 3 will be explained.

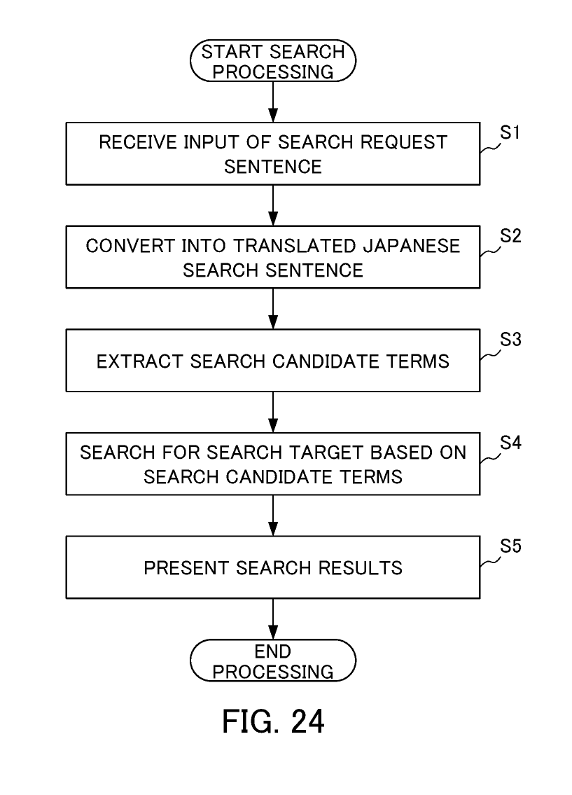

FIG. 24 is a flowchart illustrating the flow of search processing executed by the server 10 with the functional configuration of FIG. 3.

As mentioned above, the unit of the search request character string by the user is not particularly limited, and although it is not a problem even if units of terms or clauses, for example, it shall be units of sentences herein. In addition, although the language of the search request sentence is not particularly limited, it shall be a language other than a signifying language herein. In other words, when a search request sentence inputted by the user in the terminal 20 is transmitted to the server 10 via the communication network 30 from the terminal 20, search processing is initiated, and the following such series of processing is executed.

In Step S1, the search request character string input unit 401 of the server 10 in FIG. 3 receives the search request sentence.

In Step S2, the signifying language translation unit 402 converts the search request sentence of a language other than a signifying language into a Japanese search request sentence.

In Step S3, the search unit 403 executes a search using the term data in the dictionary system 405 according to the translated Japanese search request sentence, and extracts search candidate terms.

Herein, search candidate term refers to a term used upon acquiring the final search result, and in the present embodiment, indicates a term specified by an index (also including index term).

More specifically, the search unit 403, in the case of performing a general search, divides the translated Japanese search request sentence into a plurality of dismantled search elements using morphological analysis or the like. The search unit 403 sets a logical sum or the like of the plurality of dismantled search elements as the comparison source, sets each index as a comparison partner, performs matching of the comparison partner to the comparison source, and extracts a term specified in an index thus hit (case of the dial lock method being applied, synonyms also included), from the dictionary system 405 as a search candidate term.

The search unit 403, in the case of perform index reverse search, sequentially sets each of the respective indices included in the dictionary system 405 as the noted comparison source, sets the translated Japanese search request sentence as the comparison partner, and performs matching of the comparison partner with the comparison source. The search unit 403, in the case of the comparison partner including an element that mid-matches (partial match) with the noted comparison source, i.e. mid-match element, it is treated as the comparison partner hitting the noted comparison source, and the term specified by the index of the noted comparison source (in the case of the dial lock method being applied, synonyms also included) is extracted from the dictionary system 405 as a search candidate term.

It should be noted that the general search and index reverse search are not exclusive as described later, and can both be executed in parallel or one after the other.

In Step S4, the search unit 403 searches for the search target based on the search candidate term.

More specifically, in the example of FIG. 24, since illustrations are adopted as the search target, the illustrations are searched in the processing of Step S4, for example.

It should be noted that, in the case of sentence data, etc. of the Website 60 in FIG. 1 being adopted as the search target, for example, the sentence data, etc. of the Website 60 is searched in the processing of Step S4. In addition, in the case of the search target being term data in the dictionary system 405, the processing of Step S4 is omitted, and the search candidate term itself becomes the search result.

In Step S5, the presentation control unit 404 presents the search results to the user, etc. via the terminal 20, by executing control to send the search results to the terminal 20 via the communication network 30 (FIG. 1).

The search processing thereby ends.

The system 1 as an embodiment of the present invention is explained above. However, the present invention is not to be limited to the aforementioned embodiment, and modifications, improvements, etc. in a scope that can achieve the object of the present invention are also included in the present invention.

For example, in the aforementioned embodiment, the system 1 has both of the following feature 1 and feature 2. However, it is also possible to configure a system including solely feature 1 or feature 2.

Feature 1 is the feature of executing an index reverse search. Index reverse search, as mentioned above, refers to a search that sequentially sets each of the plurality of indices of the dictionary system as the noted comparison source, and performs matching that determines the presence of an element mid-matching (partial match) with the noted comparison source in this comparison partner, and causes the comparison partner to hit the noted comparison source determined as having such an element. It should be noted that the search result becomes the term, illustration, etc. specified by the index determined as having the element, not the comparison partner.

Herein, although a search request sentence is adopted in the aforementioned embodiment, it is possible for the user to make a search request using not only short units like a word or phrase, but also any units of character strings such as long units of text consisting of two or more sentences, as mentioned above. Character strings of any units for which a search request is made in this way are the aforementioned “search request character string”. In other words, the search request sentence is one example of a search request character string.

Feature 2 is the feature of using a different signifying language from the first system of symbols, in the internal processing of a search outputting search results denoted in a second system of symbols, based on the search request denoted in the first system of symbols. Processing in which such feature 2 is applied is called “signifying language internal processing” hereinafter.

Herein, symbol refers to matter conveying fixed contents to another person by social customary arrangement such as alphabetical letters, signs and marks. Therefore, languages such as Japanese and English are one type of symbolism, and illustration groups, etc. are a different type of symbolism.

In other words, as the signifying language internal processing of the aforementioned embodiment, one example is adopted of a case of a language other than a signifying language “English, etc.” being adopted as a first system of symbols, an illustration group being adopted as the second system of symbols, and Japanese being used as the signifying language used in the internal processing of the search.

Hereinafter, each of the feature 1 (index reverse search) and feature 2 (signifying language internal processing) will be explained individually in this order.

(Regarding Feature 1 (Index Reverse Search))

In the case of the search request character string being a short word, it is sufficient to adopt only a general search, since it is common to search character strings longer than this including this word (word, sentence, etc.).

However, in the case of a long search request character string (long complex term or sentence) being given, the search result (hit count) is often zero, when searching a character string longer than this, including this long search request character string.

For this reason, in a general search, the long search request character string is dismantled, and the character string including a plurality of dismantled search elements after dismantling is searched.

In this case, the point of a term that must be hit not having been hit depending on the way of dismantling is as mentioned above referencing FIG. 4.

Therefore, conversely, the points of a term completely unrelated with the semantic content of the original search request character string also being hit, and preventing this, i.e. making a high precision search, being difficult with a general search, will be explained herein.

For example, “ [symbol] [symbol] (white antique-style made of wood bookshelf in Japanese)” shall be given as the search request character string.

With a general search, the search result (hit count) is often zero when the search request character string is searched for perfect matches.

Therefore, for example, in the case of dismantling into the dismantled search elements of “ [symbol] (white in Japanese)”, “ [symbol] [symbol] (antique in Japanese)”, “ [symbol] (made of wood in Japanese)” and “ [symbol] (bookshelf in Japanese)”, and a logical sum search of these dismantled search elements being performed, it is assumed that, as a result, several unrelated results differing from “ [symbol] (bookshelf in Japanese)” will be hit.

Herein, even in a general search, it is also possible to search by “ [symbol] (white bookshelf in Japanese)”+“ [symbol] (antique in Japanese)” or “ [symbol] (white in Japanese)”+“ [symbol] [symbol] (antique bookshelf in Japanese)”, by devising a division method of the search request character string. In this case, although it is assumed that closer results are searched, i.e. is higher precision, the number of times searching is twice, and thus is not considered an efficient search.

Therefore, the present inventors devised the index reverse search as a technique for efficiently searching with high precision, even in the case of such a complex, long search request character string being given.

Herein, in the case of applying the index reverse search, the indices are assigned in advance to the search target.

FIG. 25 shows an example of indices given to each search target.

In the example of FIG. 25, specified indices including the mid-match elements of the character string of each target search are given to each of the respective search targets 1 to 8.

Search target 1: “ [symbol] ( [symbol] ) {antique bookshelf (white) in Japanese}”->Index 1: “antique, bookshelf, white”

Search target 2: “ [symbol] ( [symbol] ) {white bookshelf (made of wood) in Japanese}”->Index 2: “white, made of wood, bookshelf”

Search target 3: “ [symbol] [symbol] (antique made of wood bookshelf in Japanese)”->Index 3: “antique, made of wood, bookshelf”

Search target 4: “ [symbol] (white bookshelf in Japanese)”->Index 4: “white, bookshelf”

Search target 5: “ [symbol] (antique bookshelf in Japanese)”->Index 5: “antique, bookshelf”

Search target 6: “ [symbol] [symbol] ( [symbol] ) {antique cupboard (white) in Japanese}”->Index 6: “antique, cupboard, white”

Search target 7: “rotary-type white bookshelf”->Index 7: “ [symbol] (rotary-type, white, bookshelf in Japanese)”

Search target 8: “ [symbol] [symbol] (antique white made of wood TV stand in Japanese)”->Index 8: “ [symbol] (antique in Japanese), [symbol] (white in Japanese), [symbol] (made of wood in Japanese), [symbol] (TV stand in Japanese)”

In this way, each of the Indices 1 to 8 includes at least one of the respective elements of the Search targets 1 to 8. For example, Index 1 includes the three elements of “antique”, “bookshelf” and “white”.

In this case, an index including all of the respective elements in the search request character string of “ [symbol] [symbol] (white antique-style made of wood bookshelf in Japanese)”, i.e. respective elements of “ [symbol] (white in Japanese)”, “ [symbol] (antique in Japanese)”, “ [symbol] (made of wood in Japanese)” and “ [symbol] (bookshelf in Japanese)”, does not exist.

The indices including at least three elements in the search request character string are the Indices 1, 2, 3 and 8.

The indices including at least two elements in the search request character string are all of the Indices 1 to 8.

Therefore, in the case of a general search being performed, i.e. in the case of each element being dismantled from the search request character string as a dismantled search element, the logical sum, etc. of these dismantled search elements becoming the comparison source, and matching being performed with the respective Indices 1 to 8 being the comparison partners, there is a possibility of all of the Indices 1 to 8 being hit.

In contrast, in the case of an index reverse search being performed, the search result becomes as shown in FIG. 26.

FIG. 26 shows an example of search results in the case of an index reverse search being performed.

The point should be noted that “+” in FIG. 26 simply indicates a combination between elements, and is not the symbol of the logical sum.

First, as the noted comparison source, the logical product of the index terms of Index 1, i.e. “antique×bookshelf×white”, is set. Then, as the comparison partner, the search request character string of “white antique-style made of wood bookshelf” is set, and matching according to partial matches (mid-match) is performed. In this case, since any of “antique”, “bookshelf” and “white” is included as an element portion of this search request character string, the search request character string hits Index 1.

Similarly, in the case of each of the Indices 2 to 5 being sequentially set as the noted comparison source, the search request character string hits each of the respective Indices 2 to 5.

In contrast, in the case of the logical product of index terms of Index 6, i.e. “antique×cupboard×white”, being set as the noted comparison source, and the search request character string of “ [symbol] [symbol] (white antique-style made of wood bookshelf in Japanese)” being set as the comparison partner, “ [symbol] (cupboard in Japanese)” is not partially matched (mid-match). Therefore, the search request character string does not hit Index 6.

Similarly, since “ [symbol] (rotary type in Japanese)” does not partially match (mid-match) for Index 7, the search request character string does not hit Index 7. Since “ [symbol] (TV stand in Japanese)” does not partially match (mid-match) for Index 8, the search request character string does not hit Index 8.

By configuring in this way, hits of the indices that are completely unrelated with the semantic content of the original search request character string (Indices 6 to 8 in the example of FIG. 26) are prevented by applying the index reverse search. In other words, even in a case of a complex, long search request character string being given, it is possible to efficiently search with high precision.

Herein, the elements included in the indices are given as data; therefore, the form of the data thereof is not particularly limited, and may be text data, or may be code (signs).

In the case of adopting a sequence of code as the index, it is possible to apply the dial lock method to the index reverse search, as shown in FIG. 27.

Dial lock method refers to a method that performs management by assigning identifiers with an equivalent term group as a dictionary unit (dial lock), and can perform a search using the constituent terms (equivalent term group) of the dictionary unit, as mentioned above by referencing FIGS. 5 to 23.

In other words, by giving an array of identifiers indicating dictionary units (dial lock) as an index to a predetermined search target, it is possible to apply the dial lock method to an index reverse search.

FIG. 27 shows an example of dictionary units in the case of applying the dial lock method to an index reverse search.

In FIG. 27, the identifier “A01” indicates a dictionary unit having “antique”, and the synonyms thereof of “curio” and “old fashion” as constituent terms.

The identifier “B01” indicates a dictionary unit having “ [symbol] (made of wood in Japanese)” and the synonyms thereof of “wood” and woody” as constituent terms.

The identifier “C01” indicates a dictionary unit having “white [Japanese kanji]”, and the synonyms thereof of “white [Japanese katakana]” and “pure white” as constituent terms.

The identifier “D01” indicates the dictionary unit having “bookshelf” and the synonyms thereof of “shelf” and “bookrack” as constituent terms.

In this case, to each of the respective Search targets 1 to 8 in the example of FIG. 25, although not illustrated, it is possible to assign the following such indices.

Search target 1: “antique bookshelf (white)”->Index 1: “A01, D01, C01”

Search target 2: “white bookshelf (made of wood)”->Index 2: “C01, D01, B01”

Search target 3: “antique made of wood bookshelf”->Index 3: “A01, B01, D01”

Search target 4: “white bookshelf”->Index 4: “C01, D01” Search target 5: “antique bookshelf”->Index 5 “A01, D01”

Search target 6: “antique cupboard (white)”->Index 6: “A01, identifier indicating cupboard (undefined in FIG. 27), C01”

Search target 7: “rotary type white bookshelf”->Index 7: “identifier indicating rotary type (undefined in FIG. 27), C01, D01”

Search target 8: “antique white made of wood TV stand”->“A01, C01, B01, identifier indicating TV stand (undefined in FIG. 27)”

Herein, a case is considered of the search request character string B of “ [symbol] [symbol] [symbol] [symbol] (Old fashion style of White Woody book rack in Japanese)” constituted by synonyms being given in place of the search request character string A of “ [symbol] [symbol] (white antique-style made of wood bookshelf in Japanese)”.

In this case, even if the search request character string A hits, there is a possibility of the search request character string B constituted by synonyms not hitting, in the case of Index 1 in the example of FIG. 25 to which the dial lock method is not applied being given.

In contrast, in the case of the aforementioned Index 1 to which the dial lock method is applied being given, not only the search request character string A, but also the search request character string B constituted by synonyms hits.

In this way, it is further possible to perform a broad, high precision search also including synonyms, by applying the dial lock method to the index reverse search.

It should be noted that the search request character string may be short such as a word, as mentioned above. For example, in the case of a search request character string of “bookshelf” being given, nothing will be hit by a search of AND (logical product) of the aforementioned index terms.

Therefore, so as to be able to perform an appropriate search even when any search request character string is given, it is suitable if performing both ways of general search and index reverse search.

Furthermore, in this case, it is suitable also for the general search due to an efficient search becoming possible, when applying the dial lock method, dismantling into a plurality of dismantled search elements by the dictionary units (dial lock) from the search request character string, and searching indices by setting AND (logical product) of these plurality of dismantled search elements (dictionary units) as the comparison source.

More specifically, for example, in the case of the dictionary units (dial locks) in the example of FIG. 27 being used, even when the search request character string of “ [symbol] [symbol] (book rack made of wood in Japanese)” is given, or when the search request character string of “ [symbol] (book shelf made of wood in Japanese)” is given, since the comparison source will both be identical as the logical product of “B01” and “D01”, the same search is realizable.

Herein, index reverse search, i.e. the technique of searching a search request character string (character string generally inputted as the search query) from the index side, is more effective when applied to a case of the index side being small (case of a small number set as the noted comparison source).

For example, in the case of the search target being an illustration group as in the aforementioned embodiment, since the number of illustrations is limited, it is suitable when applying the index reverse search.

Furthermore, since there are also cases where it is possible to realize a plurality of equivalent terms with one illustration, it is more suitable when applying the dial lock method and index reverse search to a search in which the search target is an illustration group.

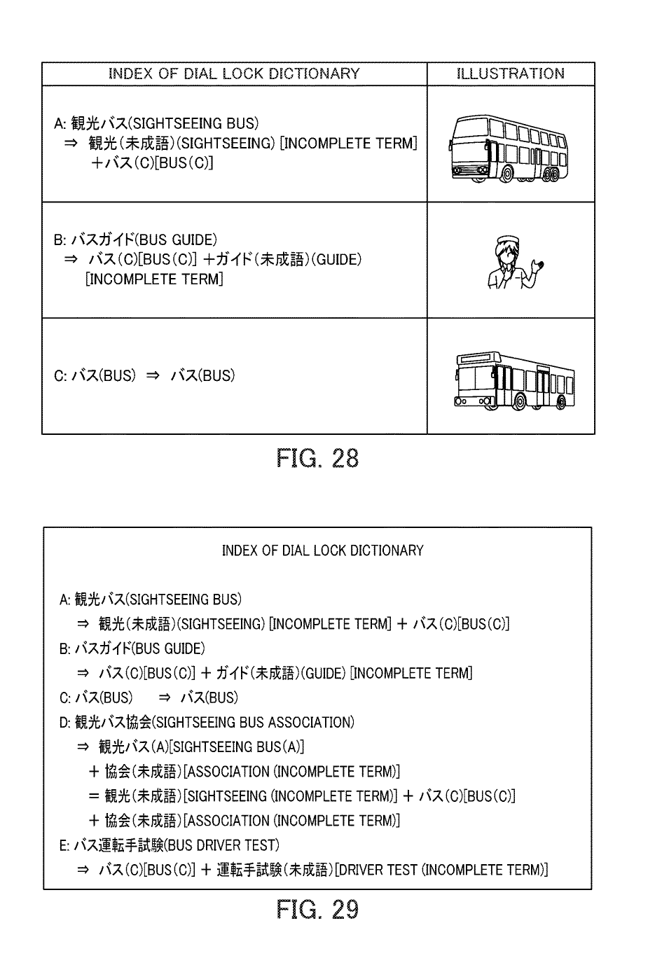

Therefore, an example in the case of applying the dial lock method and index reverse search to a search in which the search target is an illustration group will be explained by referencing FIGS. 28 and 29 hereinafter.

FIG. 28 shows a structural example of the illustration dictionary system 530 of FIG. 3, in the case of applying the dial lock method and index reverse search to a search in which the search target is an illustration group.

In the example of FIG. 28, the dictionary units of complex terms of “sightseeing bus” is indicated by identifier A, and configured by “sightseeing (incomplete term)+bus (C)”. Herein, “+” indicates a combination, and “term (a)” indicates the identifier a of the dictionary unit including this term. It should be noted that terms not included in the dictionary units are indicated as “term (incomplete term)”. In other words, “sightseeing bus” is understood to be constituted by the combination of the incomplete term “sightseeing” and “bus”, which is referenced by identifier C.

The identifier A indicating this “sightseeing bus” is assigned as an index, and is associated with an illustration of “sightseeing bus”.

Similarly, the dictionary unit of the complex term of “bus guide” is indicated by the identifier B, and is configured from “bus (C)+guide (incomplete term)”. In other words, “bus guide” is understood to be configured by the combination of “bus”, which is referenced by the identifier C, and the incomplete term of “sightseeing”.

The identifier B indicating this “bus guide” is assigned as an index, and is associated with an illustration of “bus guide”.

In addition, the dictionary unit of the simple term of “bus” is indicated by the identifier C.

The identifier C indicating this “bus” is assigned as an index, and is associated with an illustration of “bus”.

A case will be considered of such an illustration dictionary system 530 existing, and the search request character string of “sightseeing bus guide” being given.

In the case of being a general search, and a mid-match search being performed, nothing is hit, i.e. no illustrations are presented.

Therefore, a case will be considered of being a general search, dismantling the search request character string of “sightseeing bus guide”, and matching being performed with the logical sum (or) of the dismantled search elements of “sightseeing” and “bus guide”, and the logical sum (or) of the dismantled search elements of “sightseeing bus” and “guide” as the comparison source, and the indices as the comparison target.

In this case, the identifier B in the indices hits the logical sum (or) of the dismantled search elements of “sightseeing” and “bus guide”. In other words, since “bus guide” is hit, only the illustration of “bus guide” is presented as a search result.

In addition, the identifier A in the indices hits the logical sum (or) of the dismantled search elements of “sightseeing bus” and “guide”. In other words, since “sightseeing bus” is hit, only the illustration of “sightseeing bus” is presented as a search result.

Herein, in a general search, since it is difficult to present search results relating to comparison sources of two ways, it is assumed that the search results related to either one of the comparison sources is presented. For this reason, only an illustration of “bus guide” or an illustration of “sightseeing bus” is presented as the search result. In such search results, it is difficult to accurately convey the semantic content of the search request character string of “sightseeing bus guide” to a third party.

In contrast, when an index reverse search is executed, all of the identifiers A, B and C become the target of hits in the following way.

In other words, in the index reverse search, first, the identifier A in the indices is set as the noted comparison source. More specifically, the logical product (and) of “sightseeing” and “bus” is set as the noted comparison source. Therefore, the search request character string of “sightseeing bus guide” of the comparison partner hits this noted comparison source.

Next, the identifier B in the indices is set as the noted comparison source. More specifically, the logical product (and) of “bus” and “guide” is set as the noted comparison source. Therefore, the search request character string of “sightseeing bus guide” that is the comparison partner hits this noted comparison source.

Next, the identifier C in the indices is set as the noted comparison source. More specifically, “bus” is set as the noted comparison source. Therefore, the search request character string of “sightseeing bus guide” that is the comparison partner hits this noted comparison source.

Therefore, as the search result, the illustration of “sightseeing bus”, the illustration of “bus guide”, and the illustration of “bus” are presented.

A third party can thereby assume with a certain degree of accuracy the semantic contents of the search request character string of “sightseeing bus guide”, from the combination of these three illustrations.

Furthermore, even in a case of the search request character string of “bus sightseeing guidance” being given, for example, the illustrations of the identifiers A and C will be the targets of hits in the following way, by the index reverse search being executed.

In other words, with the index reverse search, first, the identifier A in the indices is set as the noted comparison source. More specifically, the logical product (and) of “sightseeing” and “bus” is set as the noted comparison source. Therefore, the search request character string of “bus sightseeing guidance” that is the comparison partner hits this noted comparison source.

Next, the identifier C in the indices is set as the noted comparison source. More specifically, “bus” is set as the noted comparison source. Therefore, the search request character string of “bus sightseeing guidance” that is the comparison partner hits this noted comparison source.

Therefore, as the search result, the illustration of “sightseeing bus” and the illustration of “bus” will be presented.

A third party can thereby assume with a certain degree of accuracy the semantic contents of the search request character string of “bus sightseeing guidance”, from the combination of these two illustrations.

In addition, for example, even in the case of the search request character string of “bus sightseeing with guide” being given, the indices of the identifiers A, B and C become the targets of hits in the following way, by the index reverse search being executed.

In other words, with the index reverse search, first, the identifier A in the indices is set as the noted comparison source. More specifically, the logical product (and) of “sightseeing” and “bus” is set as the noted comparison source. Therefore, the search request character string of “bus sightseeing with guide” that is the comparison partner hits this noted comparison source.

Next, the identifier B in the indices is set as the noted comparison source. More specifically, the logical product (and) of “bus” and “guide” is set as the noted comparison source. Therefore, the search request character string of “bus sightseeing with guide” that is the comparison partner hits this noted comparison source.

Next, the identifier C in the indices is set as the noted comparison source. More specifically, “bus” is set as the noted comparison source. Therefore, the search request character string of “bus sightseeing with guide” that is the comparison partner hits this noted comparison source.

Therefore, as the search result, the illustration of “sightseeing bus”, the illustration of “bus guide”, and the illustration of “bus” will be presented.

A third party can thereby assume with a certain degree of accuracy the semantic contents of the search request character string of “bus sightseeing with guide”, from the combination of these three illustrations.

In other words, by applying the dial lock method, a search that is not concerned with the positional relationship of the dictionary units (dial locks) of each simple term becomes possible. For example, for the index indicating “sightseeing bus”, so long as being a search request character string in which “sightseeing” and “bus” are included, it will be possible to cause this search request character string to be hit irrespective of the positional relationship of “sightseeing” and “bus”.

In this way, flexible searches become possible by applying the dial lock method, and as a result thereof, search accuracy improves.

It should be noted that, even when a general search, for the search request character string of “sightseeing bus guide”, “bus sightseeing guidance” or “bus sightseeing with guide”, it is possible to have all of the indices hit, by dismantling so as to including “bus” as the dismantled search element, selecting only this “bus”, and searching indices by mid-match.

However, with such a technique by way of a general search, unwanted search results will often be outputted in the case of the indices being more complex.

FIG. 29 shows an example of further assigning an index to the indices of the dial lock dictionary in the example of FIG. 28.

It should be noted that illustrations are omitted from the example in FIG. 29.

In the example of FIG. 29, the indices of identifiers D and E are added in addition to the same identifiers A, B and C as FIG. 28.

In other words, the dictionary unit of the complex term of “sightseeing bus association” is indicated by the identifier D, and is constituted by “sightseeing bus (A)+association (incomplete term)”=“sightseeing (incomplete term)”+“bus (C)”+“association (incomplete term)”. In other words, “sightseeing bus association” is understood to be constituted by the combination of “sightseeing bus” referenced by the identifier A and the incomplete term “association”, or the combination of the incomplete term “sightseeing”, “bus” which is referenced by the identifier C, and the incomplete term “association”.

The identifier [symbol] indicating this “sightseeing bus association” is assigned as an index, and although not illustrated in FIG. 29, is associated with an illustration of “sightseeing bus association”.

The dictionary unit of the complex term of “bus driver test” is indicated by the identifier E, and is constituted by “bus (C)” and “driver test (incomplete term)”. In other words, it is understood that “bus driver test” is constituted by the combination of “bus” which is referenced by the identifier C, and the incomplete term “driver test”.

The identifier E indicating this “bus driver test” is assigned as an index, and although not illustrated in FIG. 29, is associated with an illustration of “bus driver test”.

In the case of the search request character string of “sightseeing bus guide” being given, if dismantling so as to include “bus” as the dismantled search element, selecting only this “bus”, and searching indices by mid-match as a general search, it will cause unwanted indices such as identifiers D and E, indices having a different semantic content from the search request character string, to be hit.

In contrast, in the case of the search request character string of “sightseeing bus guide” being given, with the index reverse search, the indices of the identifiers A, B and C can be caused to hit as mentioned above, as well as the unwanted indices like the identifiers D and E being able to not be hit (excluded) as described later.

In other words, for the index reverse search, a case of the identifier D in the indices being set as the notice comparison target, more specifically, a case of the logical product (and) of “sightseeing bus” and “association”, and the logical product (and) of “sightseeing”, “bus” and “association” being set as the notice comparison target, will be considered. In this case, the search request character string of “bus sightseeing guidance” that is the comparison target will not hit (exclude) this noted comparison source, in the point of not including “association” as an element.

Next, a case of the identifier D in the indices being set as the noted comparison source, i.e. a case of the logical product (and) of “bus” and “driver test” being set as the noted comparison source, will be considered. In this case, the search request character string of “bus sightseeing guidance” that is the comparison partner will not hit (is excluded) this noted comparison source” in the point of not including “driver test” as an element.

Herein, the technique of searching explained with the example of the aforementioned FIG. 28 or FIG. 4 is a technique that presents illustrations denoting the semantic content of the search request character string as the search result to the user or the like, in the case of any search request character string being given by the user. In other words, such a technique of searching is also considered a technique of translating the search request character string from a predetermined language into illustrations, and is called “illustration translation” hereinafter.

The language of the translation source in the illustration translation is not particularly certified, and English may be adopted, for example. In other words, it is also possible to directly translate into an illustration from a search request character string in English.

However, as the language of the translation source in illustration translation, it is suitable to adopt a signifying language, particularly Japanese. Hereinafter, the reasons for which Japanese is suitable will be explained while comparing with English, which is a representative example of a language other than a signifying language.

For example, English is constituted by limited character types, and since many expressions are represented by a single word, the specificity of one word is low. In contrast, with Japanese, even if only one word (character), it is often the case that it has a meaning with high specificity. For this reason, if adopting Japanese as the translation source of illustrations, illustration translation with high accuracy can be realized, as well as drastically shortening the process for creation of the illustration dictionary system 530 (FIG. 3) required in illustration translation.

More specifically, the Japanese search request character string of “ [symbol] (not like cameras in Japanese)” shall be given, for example.

In this case, it is possible to specify one illustration showing the semantic contents thereof with only “ [symbol] (camera in Japanese)”, and it is possible to specify one illustration showing the semantic contents thereof with only “ [symbol] (not like in Japanese)”. This matter can adapt to various expressions. In other words, even when the search request character string is given by various expression such as “ [symbol] [symbol] (not like cameras in Japanese)” and “ [symbol] [symbol] (I don't want my picture taken in Japanese)”, it is possible to present the same illustration group (combination of the illustration of “photograph” and the illustration of “dislike”) to the user or the like.

In other words, by simply storing the illustration of “photograph” and the illustration of “dislike” one by one, the illustration dictionary system 530 becomes able to handle many expressions.

In contrast, the English search request character string of “not like cameras” shall be given to correspond to “ [symbol] [symbol] (not like cameras in Japanese)” in Japanese.

In this case, with the illustration dictionary system 530, in the case of the illustration of “camera” being associated with the English word of “camera”, since the illustration of “camera” will be presented to the user or the like, there is a possibility of the user or the like to mistake as not the matter of “photographs” being taken, but rather the matter of photographing by “camera” being disliked. In other words, the precision will worsen as an illustration translation.

Therefore, in order to make an illustration translation with high precision, the requirement arises not to associate the English word and illustration, but rather to associate the English phrase and illustration. However, for a phrase of one meaning, often several expressions exist in English, and upon creating an illustration dictionary system 530, the requirement arises to associate (register) phrases of these several expressions with illustrations, one-by-one. For example, as the phrase of the meaning “dislike photographs { [symbol] [symbol] (not like cameras in Japanese)}”, the requirement arises of registering phrases of various types of expressions such as “photoshy” and “I don't want my picture taken”, other than the aforementioned “not like cameras”, in the illustration dictionary system 530.

In addition, for example, with illustration translation, it is necessary to select an illustration group showing the semantic content of the search request character string from the illustrations registered in the illustration dictionary system 530.

In the case of a Japanese search request character string being given, a single word (Japanese single word) included therein is often a combination of a plurality of elements of ideographic character (kanji) units; therefore, it is easy to select an illustration showing the meaning of each element (ideographic character). In other words, so long as being a Japanese search request character string, the presentation of an illustration group showing a certain degree of the semantic content thereof becomes easily feasible.

In contrast, in the case of an English search request character string being given, when the English words included therein are a combination of a plurality of elements each denoting a predetermined meaning, it is very difficult to select illustrations showing the meaning of each element.

More specifically, for example, the Japanese search request character string of “dentist” is given, and an illustration associated with “dentist” shall be unregistered in the illustration dictionary system 530.

In this case, it is possible to dismantle the search request character string and understand as a combination of the element “tooth” and the element “doctor”. These elements (characters) each have a meaning with high specificity. Therefore, so long as the illustration of “tooth” and illustration of “doctor” are registered in the illustration dictionary system 530, it is possible to present the combination of the illustration of “tooth” and illustration of “doctor” to the user or the like.

The user or the like can easily recognize “dentist” from the combination of the illustration of “tooth” and illustration of “doctor”.

In contrast, for example, the search request character string of “Dentist” in English is given, corresponding to “ [symbol] [symbol] (dentist in Japanese)” in Japanese, and an illustration associated with “Dentist” shall be unregistered in the illustration dictionary system 530.

“Dentist” in English is considered to denote the meaning of “tooth” and “person” by the combination of the element “dent” and the element “ist”. However, the element “dent” and element “ist” have no specificity, due to being usable even as single words or word elements of different semantic content. For example, “dent” can be used even as a word of the meaning of “ [symbol] (dent in Japanese)” in Japanese. In addition, the word “student” having a different meaning of “ [symbol] (student in Japanese)” in Japanese also exists as a different English word including the element “dent” as an element.

Therefore, the matter of showing “Dentist” in English by a distinct illustration group is very difficult, unless an illustration directly associated with “Dentist” in English is registered in the illustration dictionary system 530.

In this way, conversion of “signifying language (particularly Japanese)”->“illustration” is suitable in illustration translation.

However, in the case of the search request character string being limited to a signifying language (Japanese), for a user with a language other than this signifying language as their native language, it is very inconvenient. In other words, it is suitable if constructing a system that receives various languages as the search request character string.

For this reason, it may be applied jointly with feature 2 (signifying language internal processing) explained next. In other words, it is suitable if constructing a system so as to make processing of the flow of “input: search request character string in multiple languages such as English”->“internal processing: signifying language (particularly Japanese)”->“search result, etc. output: illustration” becomes feasible.

The system 1 performing illustration translation having both of such feature 1 (index reverse search) and feature 2 (signifying language internal processing), and to which the dial lock method is further applied as necessary, is the aforementioned embodiment explained by referencing FIGS. 3, 4, etc.

Feature 1 (index reverse search) has been explained above. Next, feature 2 (signifying language internal processing) will be explained.

Feature 2 (Signifying Language Internal Processing)

Signifying language is a language using ideographic characters such as kanji. A representative example of a signifying language is Japanese. Ideographic characters retain the meaning thereof in complex terms and verb phrases, as mentioned above as a reason for being suitable to use in illustration translation. Therefore, it is suitable to adopt a signifying language as the language used as the internal processing of searching.

In the aforementioned embodiment explained using FIGS. 3, 4, etc., the signifying language internal processing was explained in the case of being illustration translation, i.e. in the case of the search target being an illustration group.

However, in a search in which signifying language internal processing is applied, the search target is not particularly limited to illustration groups, and may be arbitrary.

Therefore, as the search target herein, the same language as the search request character string, e.g., English phrases, etc., shall be adopted to explain the signifying language internal processing. In other words, herein, signifying language internal processing for which the flow of “input: English search request character string”->“internal processing: Japanese”->“search result output: English phrase, etc.” is possible will be explained.

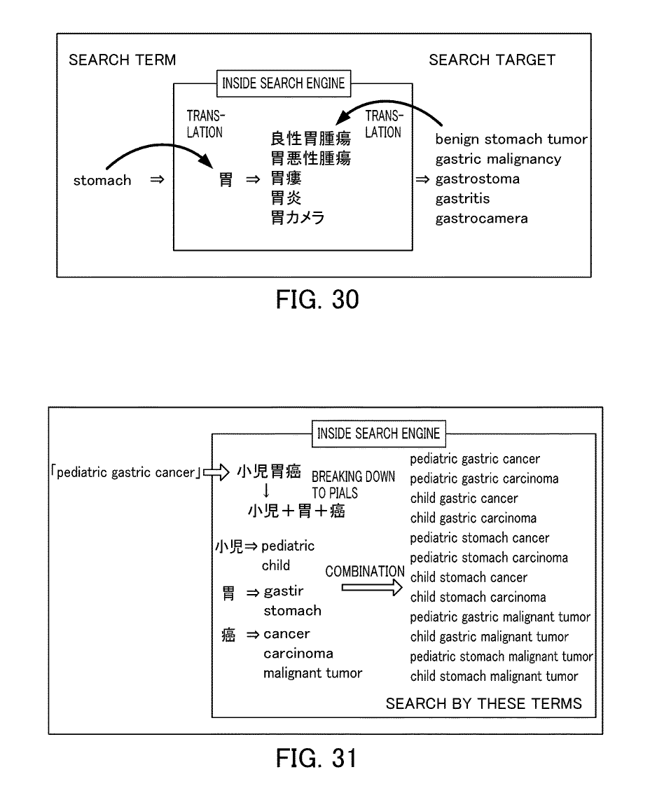

FIG. 30 is a schematic view showing an example of the outline of a search system made by applying signifying language internal processing.

In the example of FIG. 30, the search request character string of the input and the output of the search result are performed in English.

Therefore, as shown in FIG. 30, the search target is an English phrase, etc.

Therefore, the search engine translates the search request character string into Japanese, as well as translating the search target (candidates causing hits) into Japanese. It should be noted that the timing of translation of the search target into Japanese is not particularly limited; however, in order to realize high-speed processing, etc., it is ideal if before input of the search request character string.

The search engine executes a search using the Japanese search request character string and the Japanese search target. It should be noted that the technique of searching is not particularly limited, and may only be a general search; however, it is suitable if configured to also include feature (index reverse search) as mentioned above.

More specifically, for example, a case will be considered assuming a search being executed using the English search request character string and English search target.

For example, in the case of “stomach” being given as the English search request character string, only the one phrase of “benign stomach tumor” is hit among the English search targets.

In addition, for example, in the case of “gastric” being given as the English search request character string, only the one phrase of “gastric malignancy” is hit among the English search targets.

In addition, for example, even if “gastro . . . ” is given as the English search request character string, and a search of “begins-with match gastro” being performed, only the two phrases of “gastrostoma” and “gastrocamera” are hit among the English search targets.

In contrast, inside of the search engine of the example in FIG. 30, the aforementioned search request character strings in English are translated into Japanese including the element of “stomach”. In addition, the search targets are also all translated into Japanese including the element of “stomach”. As a result thereof, the search engine can cause all of the search targets to be hit.

In this way, the search engine can cause portions having the same meaning for the search request character string and search target to be hit by the same idiographic character (kanji, etc.).

In addition, since processing of translating into Japanese is executed by the internal search engine, it is possible to also build any algorithm as a translation algorithm into the search engine. For example, by building in an algorithm characterized by translation in which ideographic characters (kanji, etc.) are more often used, it is possible to further improve the accuracy and efficiency in searching of the search engine.

FIG. 31 is a schematic view showing an example of an outline of a search system applying the signifying language internal processing, which is a different example from FIG. 30.

In the example of FIG. 31, the dial lock dictionary is the search target. In other words, as the constituent terms of each dictionary unit in the dial lock dictionary, English phrases, etc. are set. Set as referred to herein indicates the matter of including the corresponding terms in Japanese, as well as synonyms thereof, in a predetermined dictionary unit.

For example, in the example of FIG. 31, in the dictionary unit for the term in Japanese of “ [symbol] (pediatric or child in Japanese)”, the English of “pediatric” and “child” are included as synonyms (are set). Similarly, in the dictionary unit for the term in Japanese of “ [symbol] (gastric or stomach in Japanese)”, the English of “gastric” and “stomach” are included as synonyms (are set). In the dictionary unit for the term in Japanese of “ [symbol] (cancer or carcinoma in Japanese)”, the English of “cancer”, “carcinoma” and “malignant tumor” are included as synonyms (are set).

In this case, in the case of the search request character string in English of “pediatric gastric cancer” being given, the search engine translates this search request character string into the Japanese of “ [symbol] (pediatric gastric cancer in Japanese)”.

Then, the search engine causes terms to be hit in the dictionary units of the dial lock dictionary (identifiers specifying these) from “ [symbol] (pediatric gastric cancer in Japanese)” (may be understood when dismantled). (Such processing is also called “dialing”.) The technique of dialing is not particularly limited and may be only a general search; however, it is suitable if configuring so as to also include feature 1 (index reverse search), as mentioned above.

By way of dialing, the Japanese terms of “ [symbol] (pediatric or child in Japanese)”, “ [symbol] (gastric or stomach in Japanese)” and “ [symbol] (cancer or carcinoma in Japanese)” are extracted (although not illustrated, more accurately, identifier of each dictionary unit in which each term is included). Therefore, the search engine can generate the plurality of (assumed) English phrases shown in FIG. 31, by combining each English term set as a synonym of the term (Japanese) of these dictionary units in any order.

It should be noted that, in this case, since it is assumed that character strings consisting of unwanted combinations not actually used in English (noise) will also appear, the search engine can cause only phrases actually existing in the English language to be hit, by searching each phrase actually existing in the English language as the search target, using English phrases generated by dialing (and assumed alphabetic character strings) as search candidate terms.

In this way, it is understood to be further suitable if applying the dial lock method to feature 2 (signifying language internal processing).

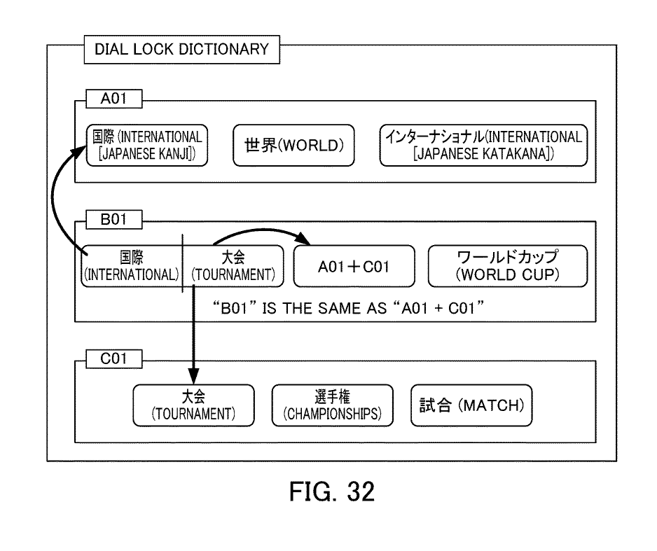

Furthermore, a case in point of when applying the dial lock method to feature 2 (signifying language internal processing) will be explained by referencing the drawings of FIG. 32 and later.

FIG. 32 shows an example of a dial lock dictionary.

In the example of FIG. 32, “international”, “world” and “international [katakana]” are included as synonyms in the dictionary unit indicated by the identifier A01. In the dictionary unit indicated by the identifier C01, “tournament”, “championship” and “bout” are included as synonyms.

In the dictionary unit indicated by the identifier B01, “international tournament” and “world cup” are included as synonyms. “International tournament” is constituted also as “A01+C01”, since it can be understood as a complex term of “international” and “tournament”. Herein, “+” indicates a combination. In other words, “international tournament” is defined as a complex term of the term included in the dictionary unit referenced by the identifier “A01”, and the term included in the dictionary unit referenced by the identifier “C01”.

Herein, a case is considered of “World Judo Championships” (hereinafter called “first search request”), “International Judo meet” (hereinafter called “second search request”), “Judo International Tournament” (hereinafter called “third search request”) and “Judo World Cup” (hereinafter called “fourth search request”) being given as English search request character strings.

In this case, inside the search engine, with feature 2 (s internal processing), the first search request is translated into the Japanese of “ [symbol] (world judo championships in Japanese)” (hereinafter called “first translated text”), the second search request is translated into the Japanese of “ [symbol] [symbol] (international judo meet in Japanese)” (hereinafter called “second translated text”), the third search request is translated into the Japanese of “ [symbol] (judo international tournament in Japanese)” (hereinafter called “third translated text”), and the fourth search request is translated into the Japanese of “ [symbol] [symbol] (judo world cup in Japanese)” (hereinafter called “fourth translated text”).

Then, each of the first translated text to fourth translated text is divided into the respective dictionary units of the dial lock direction (subjected to dialing), and then coded.

More specifically, the first translated text is coded as “A01+ [symbol] (judo in Japanese kanji)+C01”, the second translated text is coded as “A01+ [symbol] (judo in Japanese kanji)+C01”, the third translated text is coded as “ [symbol] (judo in Japanese kanji)+A01+C01”, and the fourth translated text is coded as “ [symbol] (judo in Japanese kanji)+B01”=“ [symbol] (judo in Japanese kanji)+A01+C01”.

Herein, with the dial lock method, since it is possible to freely change the sequence of each code (identifier) (such a search is possible), for example, when rearranging the identifier+incomplete term each code in JIS order, all of the codes also become “A01+C01+ [symbol] (judo in Japanese kanji)”.

In other words, even in the case of any of the first search request to fourth search request in English being given, it is possible to cause the code of “A01+C01+ [symbol] (judo in Japanese kanji)” to be hit in a perfect match. In other words, even in the case of any of the first search request to fourth search request in English being given, it becomes possible to search for all Japanese that can combine by rearranging each identifier based on “A01+C01+ [symbol] (judo in Japanese kanji)”. In other words, even in the case of any of the first search request to fourth search request being given, it becomes possible to search for all possible Japanese including the first to fourth translated text, not only the corresponding translated text.

More specifically, even if different types of ways are adopted as the algorithm for translation from English to Japanese, in the case of any of the first search request to fourth search request being given, it is possible to search for all possible Japanese. More specifically, although “ [symbol] [symbol] (world judo championships in alternate Japanese spelling)” is adopted in the aforementioned example as the first translated text for the first search request in English, for example, “ [symbol] (world judo championships in alternate Japanese spelling)” may be adopted depending on the type of algorithm. Even in such a case, the matter of being coded as “A01+C01+ [symbol] (judo in Japanese kanji)” will not change, and thus the same search result will be obtained.

By applying the dial lock method to feature 2 (signifying language internal processing) in this way, after converting the search request character string into a translated Japanese search request character string, this translated Japanese search request character string is subjected to dialing, and coding including incomplete terms (assignment of identifier) is done, whereby it is possible to cause all relevant Japanese to be hit, even by searching with any search request character string.

In other words, the code including incomplete terms (combination of identifiers) is defined in advance as an index, whereby the same index will be hit, even in the case of English search request character strings in different ways of expression being given. Using this index as the search candidate term, the same search results will be obtained by searching the Japanese search target.

More specifically, “ [symbol] (international judo meet in Japanese)” shall be included in the search target (Japanese sought to be hit). This “ [symbol] (international judo meet in Japanese)” becomes the code of “ [symbol] (judo in Japanese kanji)+A01+C01”, when rearranging into JIS order after performing coding (assigning identifiers) including incomplete terms by way of dialing. Therefore, if the code of “ [symbol] (judo in Japanese kanji)+A01+C01” already exists as an index, the index of “ [symbol] (international judo meet in Japanese)” will be extracted as the search candidate term, even in a case of any of the first search request to fourth search request being given, and the search target will be searched using this index; therefore, “ [symbol] (international judo meet in Japanese)” will certainly be hit. In order words, even in the case of any of the first search request to fourth search request being given, the same search results of “ [symbol] (international judo meet in Japanese)” will be obtained.

Herein, in the case of applying the dial lock method to feature 2 (signifying language internal processing), since the processing including incomplete terms becomes possible, it is possible to exert similar effects, even if the incomplete term portion is substituted with another term.

More specifically, although the incomplete term portion is “ [symbol] (judo in Japanese)” in the example of FIG. 32, even if the incomplete term portion is substituted by “ [symbol] (tennis inJapanese)”, “ [symbol] (soccer in Japanese)” or “ [symbol] (table tennis in Japanese)”, it is possible to exert similar effects.

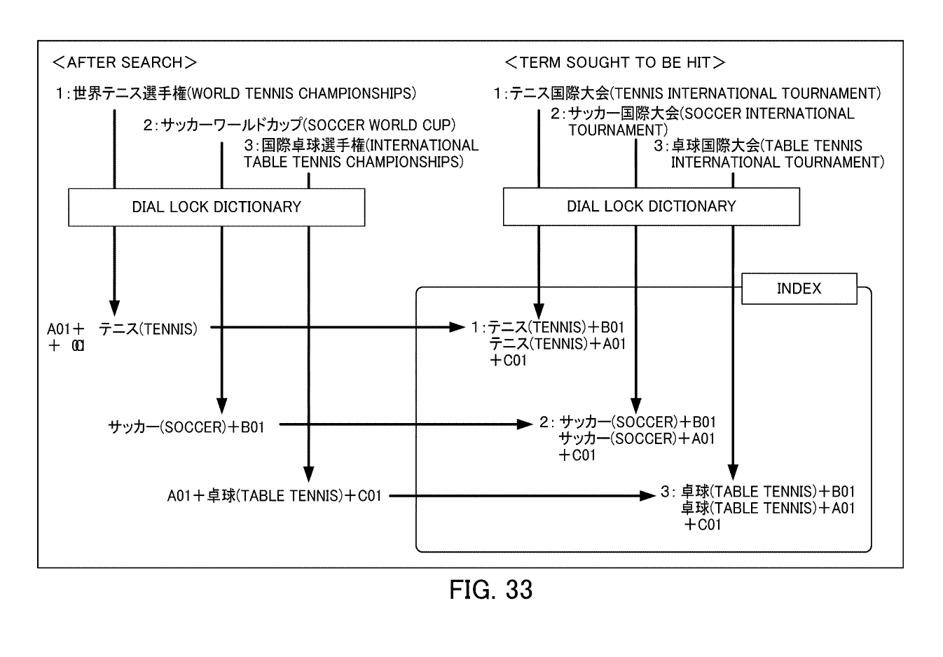

FIG. 33 shows a specific example of search results in the case of applying the dial lock method to feature 2 (signifying language internal processing).

In the example of FIG. 33, “ [symbol] (tennis international tournament in Japanese)”, “ [symbol] (soccer international tournament in Japanese)” and “ [symbol] (table tennis international tournament in Japanese)” are given as search targets (terms sought to be hit).

Then, as indices, index 1 of “ [symbol] (tennis in Japanese katakana)+B01”=“ [symbol] (tennis in Japanese katakana)+A01+C01”, index 2 of “ [symbol] (soccer in Japanese katakana)+B01”=“ [symbol] (soccer in Japanese katakana)+A01+C01”, and index 3 of “ [symbol] (table tennis in Japanese kanji)+B01”=“ [symbol] (table tennis in Japanese kanji)+A01+C01” are defined.

In this case, if “ [symbol] (tennis international tournament in alternate Japanese spelling)”, which is the Japanese translation of the English search request character string, is given as the search term, since it is coded as “A01+ [symbol] (tennis in Japanese katakana)+C01”, index 1 is hit, and as a result thereof, “ [symbol] (tennis international tournament in Japanese)” is hit.

Similarly, if “ [symbol] [symbol] (soccer international tournament in alternate Japanese spelling)”, which is the Japanese translation of the English search request character string, is given as the search term, since it is coded as “ [symbol] [symbol] (soccer in Japanese katakana)+B01”, index 2 is hit, and as a result thereof, “ [symbol] (soccer international tournament in Japanese)” is hit.

If “ [symbol] (table tennis international tournament in alternate Japanese spelling)”, which is the Japanese translation of the English search request character string, is given as the search term, since it is coded as “A01+ [symbol] (table tennis in Japanese kanji)+C01”, index 2 is hit, and as a result thereof, “ [symbol] (table tennis international tournament in Japanese)” is hit.

In this way, the dial lock method can express one or more synonyms by one dial (dictionary unit), as well as expressing complex terms by referencing to the dictionary units of each simple term serving as a constituent element thereof; therefore, it has a feature of being able to make registration of the minimum number of dictionary terms (dictionary units) to absorb the sway of written expressions.

By applying the dial lock method to feature 2 (signifying language internal processing), it is possible to put this feature to maximum practical use.

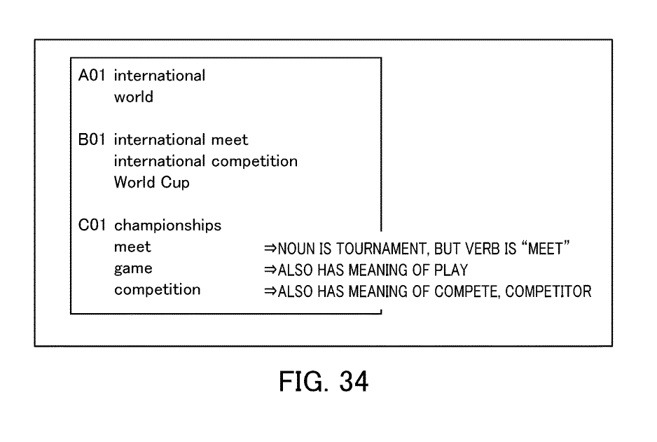

In other words, as shown in FIG. 34, a dial lock dictionary in English can also be realized.

FIG. 34 shows an example of an English dial lock dictionary.

As shown in FIG. 34, English words are often “polysemic words”, and it is often the case where it is difficult to give a unique meaning with a short partial character string (single word).

For example, since “Online game” includes “game”, when the dial lock dictionary in the example of FIG. 34 is used to code, the identifier of “C01” is assigned. However, the identifier “C01” is a dictionary unit in which synonyms with the meaning of “ [symbol] (game in Japanese)” in Japanese are stored. Herein, “Online game” has the meaning of “ [symbol] (online game in Japanese katakana)” in Japanese, and does not have the meaning of “ [symbol] (online tournament in Japanese)” in Japanese; therefore, it is not appropriate for the identifier of “C01” to be assigned.

Similarly, since “competition activity” includes “competition”, when the dial lock dictionary of the example in FIG. 34 is used to code, the identifier of “C01” is assigned. However, the identifier “C01” is a dictionary unit in which synonyms with the meaning of “ [symbol] (game in Japanese)” in Japanese are stored. Herein, “competition activity” has the meaning of “attitude in competing company” in Japanese, and does not have the meaning of “action in a bout” in Japanese; therefore, it is not appropriate for the identifier of “C01” to be assigned.

In this way, with the English dial lock dictionary, there are cases where the feature of being able to make registration of the minimum number of dictionary terms (dictionary units) to absorb the sway of written expressions is not sufficiently realized.

Herein, although a search device to which the present invention is applied is explained with the example of a server in the aforementioned embodiment, it is not particularly limited thereto.

For example, the present invention can be applied to general use electronic devices. More specifically, for example, the present invention is applicable to notebook personal computers, television sets, video cameras, portable navigation devices, portable telephones, portable game devices, etc.

The aforementioned series of processing can be made to be executed by hardware, or can be made to be executed by way of software.

In other words, the functional configuration of FIG. 3 is merely an exemplification, and it is not particularly limited. In other words, it is sufficient so long as the function of being able to execute the aforementioned series of processing as a whole is equipped to the search device, and what kind of functional blocks are used in order to realize this function is not particularly limited to the example of FIG. 3.

In addition, one functional block may be constituted by a hardware unit, may be constituted by a software unit, or may be constituted by a combination of these.

In the case of having the series of processing executed by way of software, a program constituting this software is installed from a network or recording medium to a computer or the like.

The computer may be a computer with built-in dedicated hardware. In addition, the computer may be a computer capable of executing various functions by installing various programs, e.g., a general-purpose personal computer.

The recording medium containing such a program is not only constituted by removable media distributed separately from the device itself in order to provide the program to the user, and is constituted by recording media, etc. provided to the user in a form already installed in the device itself. The removable media is constituted by magnetic disks (including floppy disks), optical disks, magneto-optical disks, or the like. Optical disk is constituted by a CD-ROM (compact disk-read only memory), DVD (digital versatile disk) or the like, for example. Magneto-optical disk is constituted by an MD (Mini-Disk), or the like. In addition, the recording medium provided to the user in the form already installed in the device itself, for example, is constituted by ROM or a hard disk on which the program is recorded.

It should be noted that, in the present specification, the steps defining the program recorded in the storage medium include not only the processing executed in a time series following this order, but also processing executed in parallel or individually, which is not necessarily executed in a time series. In addition, in the present disclosure, the terminology of system shall indicate the overall device configured by a plurality of devices, a plurality of means, etc.

### EXPLANATION OF REFERENCE NUMERALS

1 system
10 server
20 terminal
30 communication network
60 Website
105 bus line
110 input unit
120 communication interface unit
130 control unit
140 display unit
150 storage unit
205 bus line
210 input unit
220 communication interface unit
230 control unit
240 display unit
250 storage unit
401 search request character string input unit
402 signifying language translation unit
403 search unit
404 presentation control unit
405 dictionary system
510 dial lock dictionary system
520 general dictionary system
530 illustration dictionary

1. A search device for outputting a search result denoted in a second system of symbols based on a search request denoted in a first system of symbols, the search device comprising:
an input means for inputting a search request denoted in the first system of symbols from a user;
a conversion means for converting the search request denoted in the first system of symbols inputted by way of the input means into a signifying language differing from the first system of symbols; and
a search means for executing a search using the search request in the signifying language converted by the conversion means, and outputting a search result denoted in the second system of symbols.

2. The search device according to claim 1, wherein the search means:
sets, as a search target, a dictionary system in which a plurality of indices specified in the signifying language is assigned, and storing illustrations associated with each of the plurality of indices as the second system of symbols; and
outputs an illustration corresponding to an index hit by the search request in the signifying language, among the plurality of indices.

3. The search device according to claim 1 or 2, wherein the search means:
includes a storage unit that stores at least one simple term dictionary unit configured to include a simple term in the signifying language, and a complex term dictionary unit configured to include one of the simple terms constituting the simple term dictionary unit, by attaching a unique identifier to the simple term dictionary unit and the complex term dictionary unit, respectively, and sets, as a search target, a dictionary system wherein each simple term constituting the complex term is referenced via the identifier to the simple term dictionary unit; and
executes a search using a search request in the signifying language, and outputs a search result denoted in the second system of symbols.

4. A search method to be executed by a search device that outputs a search result denoted in a second system of symbols based on a search request denoted in a first system of symbols, the method comprising the steps of:
converting the search request denoted in the first system of symbols that has been inputted, into a signifying language differing from the first system of symbols; and
executing a search using the search request in the signifying language thus converted by way of processing in the step of converting, and outputting a search result denoted in the second system of symbols.

5. A program for causing a computer, which controls a search device that outputs a search result denoted in a second system of symbols based on a search request denoted in a first system of symbols, so as to execute control processing comprising the steps of:
converting the search request denoted in the first system of symbols that has been inputted, into a signifying language differing from the first system of symbols; and
executing a search using the search request in the signifying language thus converted by way of processing in the step of converting, and outputting a search result denoted in the second system of symbols.
